(19) United States
(12) Patent Application Publication
(10) Pub. No.: US 2005/0278362 A1
(43) Pub. Date: Dec. 15, 2005

(54) Knowledge discovery system

(76) Inventors: Alianna J. Maren, McLean, VA (US); Stanley Campbell, Fairfax Station, VA (US); Dennis Perry, Annandale, VA (US); Bao Nguyen, Vienna, VA (US)

Correspondence Address: FOLEY AND LARDNER LLP;SUITE 500, 3000 K STREET NW, WASHINGTON, DC, 20007, US

(21) Appl. No.: 11/059,643

(22) Filed: Feb. 17, 2005

Related U.S. Application Data
(63) Continuation-in-part of application No. 10/604,705, filed on Aug. 12, 2003.
(60) Provisional application No. 60/622,938, filed on Oct. 29, 2004.

(51) Int. Cl. G06F 7/00

(52) U.S. Cl. 707/100

(57) ABSTRACT

A knowledge discovery apparatus and method that extracts both specifically desired as well as pertinent and relevant information to query from a corpus of multiple elements that can be structured, unstructured, and/or semi-structured, along with imagery, video, speech, and other forms of data representation, to generate a set of outputs with a confidence metric applied to the match of the output against the query. The invented apparatus includes a multi-level architecture, along with one or more feedback loop(s) from any level n to any lower level n−1 so that a user can control the output of this knowledge discovery method via providing inputs to the utility function.

### CROSS-REFERENCE TO RELATED PATENT APPLICATIONS

The present application is a continuation in part of U.S. patent application Ser. No. 10/604,705 filed on Aug. 12, 2003. The application also claims priority to and the benefit of U.S. Provisional Patent Application Ser. No. 60/622,938. The foregoing is incorporated by reference herein in its entirety.

### DESCRIPTION

The present invention relates generally to the field of knowledge discovery. Three interwoven challenges govern the knowledge discovery process of extracting and representing query-relevant elements from within a data corpus.

The first challenge is achieving speed and scalability, along with computational load minimization: Specifically, accomplishing the foregoing tasks while minimizing the level of effort required by various computational processes that can be invoked to meet the query needs.

The key issue in controlling scalability, and in reducing manpower overhead, is to determine appropriate selections of filtering and processing methods and their associated parameters, applied in various combinations to corpora of source data items, where the processes govern both metadata tagging as well as information retrieval in response to queries. This is undoubtedly the most significant challenge in the data analysis and metatagging process. One reason that this is so challenging is that when metadata tagging is introduced as a result of a sequence of processing stages, the issues associated with corpora size and scalability are exacerbated. Thus, it is crucial to find a method by which knowledge discovery, inclusive of both metadata tagging and query-answering, can be done both initially and retrospectively, making use of multiple processes of increasing computational complexity, in a manner that both makes precise inquiry possible and which allows scaling to very large corpora. Viewed from one perspective, this challenge can be identified as selecting the right parameters with which to conduct discovery, although the challenge is better expressed in terms of filters, processes, and choices for both data selection, filter and processing method and parameter selection and application, and subsequent determination of appropriate processing steps.

Certain conventional processes place the user as the initial and primary element(s) of the feedback loop, where the user may optionally evaluate all of the results that are returned. But it is precisely this positioning that becomes untenable as very large corpora are considered. This process, common among most COTS tagging and search products, has clearly achieved less than satisfactory results in the challenging environment of full knowledge discovery. Even user-oriented search training functions ultimately only serve to constrain results based on the limitations of a particular tool's mathematical capabilities. The challenge of scalability is illustrated in FIG. 1, which shows how very large data corpora must be processed in order for to extract meaning relative to a given inquiry.

The second challenge is balancing precision with comprehensiveness. Effective query response, or more generally, knowledge discovery with regard to any area of interest, requires means for extracting, representing, and ranking those elements that most precisely meet the need and nature of a query. At the same time, it is also important that the returned knowledge be comprehensive with regard to the query nature and that relevant, significant, or salient information not be excluded in a desire to present a precisely focused answer. Thus, a balancing between two polarities of focused precision versus comprehensiveness and completeness, according to a set of one or more metrics is required.

The third challenge is facilitating knowledge transition and communication across multiple representation modalities to include but not be limited to discovery using text-based or linguistically-based data representations, geospatial data representations, image data representations, and other forms of sensor data representations.

Therefore an architecture is needed to address the challenges ((1) scalability along with speed and computational load minimization, (2) balance of precision with comprehensiveness, and (3) maximally drawing and correlating information across multiple representation modalities) that govern the knowledge discovery process of extracting and representing query-relevant elements from within a data corpus. First, to obtain scaling, the architecture must judiciously apply processing resources to appropriate data selections. This will enable the architecture to achieve computational load minimization to accomplish the knowledge discovery tasks while minimizing the level of effort required by various computational processes that can be invoked to meet the discovery needs. Second, to obtain precision balanced with comprehensiveness, the architecture must be capable of extracting, representing, and ranking those elements that most precisely meet the need and nature of a query within some defined metric. Supporting this objective, the architecture must also encompass the ability to recognize “emergent” patterns. In other words, knowledge discovery systems need to be able to “push” new patterns, trends, and significant anomalies to the user, rather than requiring specific, tailored inquiry that would “pull” these results. Finally, the architecture must contain means and methods by which communication of data elements across various representation modalities is facilitated, in order to draw upon all the resources that can contribute to a discovery endeavor.

Since the inception of artificial intelligence (“AI”), researchers have acknowledged the preeminent role of knowledge representation as pivotal within the development of all AI systems. In fact, this acceptance has been so fundamental and widespread that is not so much whether representations should form the basis for an intelligent processing system, but rather what representations should be used, and whether they should emphasize data or process, or both, and other such considerations.

Key results from the study of mammalian neurophysiology for complex data processing systems (e.g., image and auditory signal processing) over the past several decades have led researchers to understand that not only is representation crucial (as was understood in the early days of AI), but also that multiple representation layers are essential in dealing with complex systems dealing with large amounts of data.

In general, it is well understood that one primary goal of multiple representation levels in an intelligent system is to support data reduction; i.e., to select from a large amount of data the most important elements, typically represented at a higher level of abstraction, to present to a (typically single) “point of cognition,” whose purpose it would be to evaluate and interpret the data. Typically, the data presented at this “point of cognition” was orders of magnitude less than the number of individual data items available to and being processed by the overall system. To make good use of the representation levels, it is essential to recognize that the higher, more “abstract” representation levels typically are reached only by using the more computationally complex algorithms and processes.

When multiple representation levels are used in a biological system to address a complex processing challenge, the “lower processing levels” (i.e., those used first to process incoming data) typically perform simple operations, where these simple steps are usually performed with massively parallel processes. For example, lower levels of visual cortex processing will perform gradient-detection operations with regard to individual inputs. At slightly higher levels of processing, the operations are somewhat more complex, and will involve (again typically in parallel) a larger “neighborhood” of elements around the one being considered as the focus for each step being performed.

Through successive processing levels, the data being represented takes on an increasingly abstract nature, and will typically be represented in more compact form, and yet refer to a broader extent of coverage. For example, at higher processing levels in the visual cortex, gradient detections are combined to form edge detections, and edge detections are combined to reduce spurious edges and also to increase the continuity of certain edges. Such detections are a form of low-level data abstraction. Successive processing levels of data abstraction are also possible, resulting in representation of syntactic/perceptual characteristics of the initial input data, and leading to cognitive identification and interpretation of this data. In computer science terms, this results in “image understanding” or “speech understanding,” to name but two of well-known applications areas.

The goal of data transformation through multiple steps of processing and consequent multiple representation levels is not just data abstraction and data reduction, but also the ability to associate context as well as both general and domain-specific knowledge with the extracted and abstracted (transformed) data elements. Part of the function of the abstraction process is to allow the association described above to occur.

Typically, only a small subset of even the abstracted data produced through successive processes will receive detailed cognitive attention from the higher level processes that evaluate and interpret the processing results. This is in part due to the limitations of cognitive attention, and is part due, given current computational methods and resources, to the computational expense of performing extensive (and potentially unnecessary) processes on every element within a data corpus. In general, it is reasonable to believe that not all the data present in a given corpus will be worthy of detailed attention. Thus, the challenge is to define and apply appropriate filters at each representation level, so that the most relevant elements at each level can be selected for further processing.

Once a subset of data elements have been selected at any given representation level and further processed to a higher level and more abstract representation, it is entirely reasonable that additional data elements will be desired to be brought to the same level of representation, in order to provide further support or additional information with regard to the data subset that has initially been brought to the higher level.

The need to invoke ancillary and supporting data elements is not confined to the highest processing levels of knowledge processing, but can in fact be identified at any of the representation levels leading up to and inclusive of the highest data representation levels. Indeed, it is reasonable that at any given representation level, there can emerge a need for element representations based on either source data items that were not selected for full processing, or on data elements extracted from source data items. This need is met by one embodiment of the present invention, knowledge discovery architecture having feedback processing.

One of the most challenging aspects of knowledge discovery is that there has traditionally been a limitation in how ontologies and taxonomies can facilitate the discovery process. On the one hand, humans typically organize knowledge into certain categories that can be expressed via one or more ontology and/or taxonomy structures. Further, it is feasible, using an ontological and/or related taxonomic structure, to apply metatags to various data source items, indicating their degree of correspondence with a given ontologically or taxonomically-specific area. However, often manually-created taxonomies lack the depth that would make them as useful as desired in guiding discovery, and various strategies for automatically generating taxonomies (reaching bottom-up towards the human-generated higher-level taxonomies) do not have the degree of rigor and clarity that would be desired, and are further highly subject to the detailed wording and ordering of words within the corpora used to generate these taxonomies. Even manual “tuning” of these automatically-generated taxonomies is subject to the vagaries of human intervention, and once again become cost-prohibitive in terms of human time needed to refine and then maintain these taxonomies.

Even more than these challenges, there is a greater and overarching consideration; that of determining precisely how a taxonomy should be used to improve search and discovery, and also how the same taxonomy can create support for content management within an enterprise or organization. This is because it is generally unclear, within the community, exactly how a source data item should be correlated (i.e., metatagged) to identify its relationships to the various nodes within a taxonomy. Thus, the problem is really one of specifying the mapping(s) between a given source data item and one or more taxonomic nodes, and vice versa.

Many approaches to both ontological and taxonomic definitions overlook the essential truth that a core role in taxonomy specification is to provide essential distinctions between the various branches and nodes within a taxonomic structure. That is, at any one level of “child” nodes under a given “parent” node, it is desirable for the children to be maximally distinguishable from each other. Typically, taxonomies are organized so that the greatest and most meaningful distinctions, according to some set of criteria, occur between those items that are associated with the different taxonomic nodes.

The ability to provide for these distinctions rests on a fundamental and largely previously unexploited capability, which is that the taxonomy should be specified in such a way that guides the association of source data items towards the various taxonomic nodes. It is understood, in this sense, that the associations that will be made will typically be many-to-many. That is, any given source data item may contain within it data elements and configurations of these elements that cause the source data item to be related to a number of different taxonomic nodes, both vertically (ranging from general down to specific within a taxonomic substructure), horizontally (across a plurality of nodes that are “children” to a given “parent” node, with which the source data item may or may not be associated), and even across substructure boundaries, as there is no real limit on the content or content organization of a given source data item.

Thus, what is needed is a method and apparatus by which a taxonomy can be specified towards a given source data corpus, resulting in a precise algorithmic method of not just associating a given corpus item with one or more taxonomic nodes, but also providing for a metric by which the degree of association can be identified. Further, it is desired that there be a method of specifying the fundamental nature (membership and degree of association) of the forms of abstract data representations, e.g., concept classes, verb or relationship classes, etc., so that they can map in a known and specifiable manner to various nodes within a taxonomy, which will possibly be a many-to-many mapping. It is also desired that there be a means for determining the “distance” between the set of items associated with one node in a taxonomic structure and the sets of items associated with neighboring nodes, whether those neighbor-relations are vertical (parent-child) or horizontal (all children of same parent node). Finally, it is desired that there be a means for improving the distance between inter-node assignments, and to the extent feasible, simultaneously minimizing intra-node assignment distances.

The knowledge discovery process is often best served by integrating multiple data types within a single question-answering endeavor. As an illustration, a single query may involve: (1) linguistic information and analytics that yields concepts, along with their associations and relationships, (2) geospatial representations that allow answering questions relating to the spatial relationships between different events, and (3) contextual information and other vital intelligence that comes through database analytics and temporal reasoning, triggered by linguistic and geospatial discoveries. As various elements evolve through different aspects of knowledge discovery processing, the analytic and reasoning components of a complete knowledge discovery architecture can use this information to drive new queries into the linguistic and/or geospatial capabilities. Thus, to fully meet knowledge discovery processing requirements, a complete knowledge discovery methodology and apparatus must include the ability to work with multiple knowledge representation modalities, including, but not limited to linguistic, image-based, signal, and geospatial data and knowledge representations.

### BRIEF DESCRIPTION OF THE DRAWINGS

FIG. 1 is a block diagram that illustrates the challenge of scalability, which shows how very large data corpora must be processed in order to extract meaning relative to a given inquiry.

FIG. 2 is a block diagram of a general knowledge discovery architecture according to one embodiment of the invention.

FIG. 3 is a block diagram of an exemplary knowledge discovery architecture according one embodiment of the present invention.

FIG. 4 is a block diagram of a taxonomic structure according to one embodiment of the present invention.

FIG. 5 is a block diagram of a knowledge discovery architecture according to one embodiment of the knowledge discovery architecture.

FIG. 6 is a block diagram illustrating the relationship between a taxonomical node and a concept class according to one embodiment of the present invention.

FIG. 7 is a block diagram illustrating the variability of a feature vector element with a taxonomical node according to one embodiment of the present invention.

FIG. 8 is a block diagram illustrating the creation of concept classes given two different query areas according to one embodiment of the present invention.

FIG. 9 is a block diagram of the knowledge discovery architecture implemented on a physical computer network according to one embodiment of the present invention.

FIG. 10 is a block diagram illustrating the relationship between data items, raw data elements and aggregate raw data elements.

FIG. 11 is a block diagram illustrating the preliminary processing of a data corpus to identify aggregate raw data elements for higher level processing.

### DETAILED DESCRIPTION

One unique aspect of one embodiment of the present invention is that whereas previous approaches to knowledge discovery have typically rested on employment of a single or well-defined set of algorithms employed in a known and identified manner to a data corpus, the present invention treats the corpus analogous to a data stream in a complex signal processing system, for which multiple representation levels are reasonable. The wealth of thinking over the past decades regarding complex systems has led to identification of several well-known representation levels, e.g., the notion of “signals, signs, and symbols.” A key characteristic of this approach is that data representations are uniquely different at each representation level, where higher levels embody both greater compression of original source data into more cogent and abstract elements, to which increasingly greater amounts of context and both general and domain-specific knowledge can be associated. Higher representation levels are also more able to support (“represent”) complex relations between data elements, thus making the elements which can be represented more inherently complex.

An analogy can be made between data elements associated with specific data items in the source data corpus and a source of data providing a “signal level” data stream. What differentiates this approach from typical signal processing is that each source data item (document, web page, image, etc.) can typically contain multiple “signals,” in the form of words, images, etc. Within each data item, it is possible to extract “signals of value,” and regard the remaining material within the data item as “noise,” at least with regard to a particular query or process. As these “signals-of-value” are extracted to create various representations, filtered, and processed to generate a next-level set of data representations, they contribute to more abstract data representations. It is clear that one source data item can contain a multiplicity of “signals,” some of which may be contained more than once within a given data item. It is further apparent that in a data corpus consisting of a multiplicity of data items, that different data items can also contain essentially the same “signal” as is found in other items within the corpus. Thus, it is entirely reasonable to state that there is a many-to-many mapping between source data items and a set of data elements, which can be initially represented as a set of selected “signals of value” from one or more data items of the data corpus.

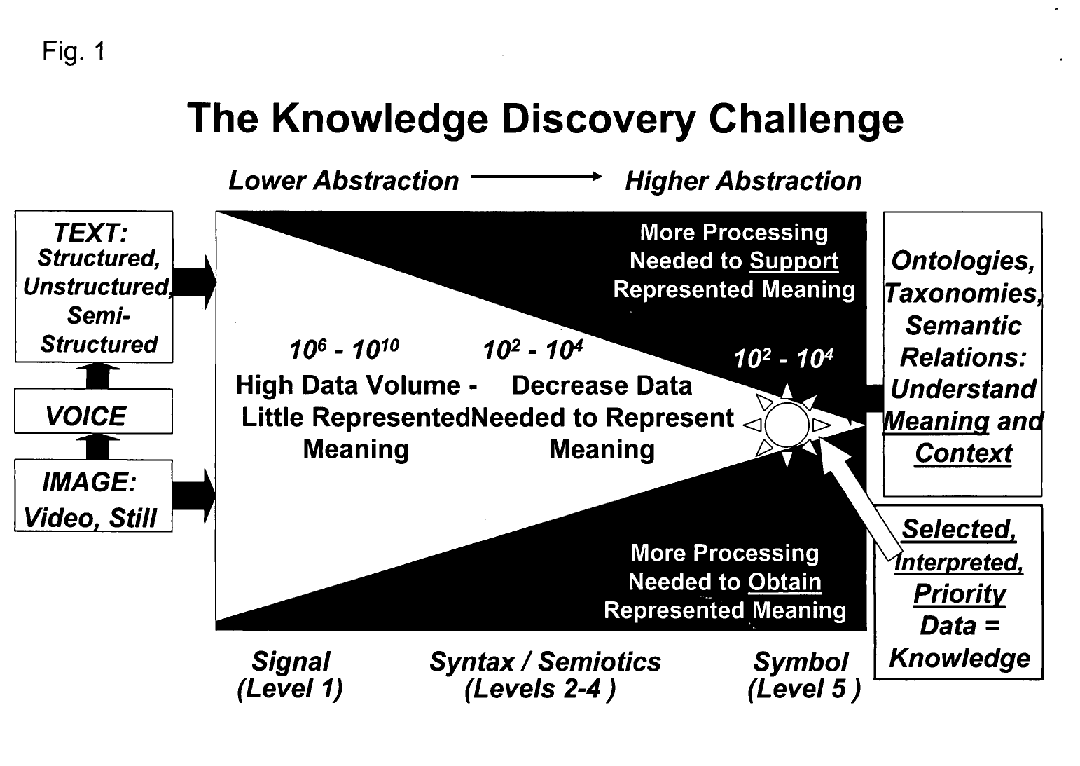

One embodiment of the present invention is particularly well-suited for very large source data corpora. The challenge with very large corpora is that of appropriately apportioning the processing attention given to different items of any given corpus and their associated data elements; often the challenge is referred to as the “scaling” problem. The approach identified in the previous subsection, of using multiple representation levels, is an essential aspect of scaling. To make good use of the representation levels, it is essential to recognize that the higher, more “abstract” representation levels typically are reached only by using the more computationally complex algorithms and processes, as illustrated in FIG. 1.

For example, one or more lower levels can be devoted to representing “signals” (e.g., selected words, word-stems, and noun or word phrases, either individually or identified as members of a given “signal classification”). One or more subsequent representation levels can be nominally dedicated to identifying associated signal classes (which could also be designated as “concept classes”), and then further subsequent representation levels devoted to representing relationships between certain selected signal or concept classes. Typically, the algorithms that identify and characterize relationships between signals (or concepts) are more computationally complex than those algorithms that simply identify and extract the various desired “signals-of-interest.” Thus, it is desirable to apply those more computationally complex algorithms and processes only where their application is likely to be of value, rather than to the entire data item corpus.

According to an embodiment of the present invention, a system for knowledge discovery from a set of structured data and/or semi-structured data and/or unstructured data elements is provided. The system includes a first filter for filtering a first representation level of the data elements and a first level processor for transforming the filtered data elements into a second representation level of the data elements. The system also includes a second filter for filtering the second representation of the data elements; and a feedback controller for automatically providing feedback to one of the filters and/or the processor and/or to the first representation level of data elements based on the filtered second representation level of the data elements. Preferably, the second representation level of the data elements is at a higher level of abstraction than the first representation level of the data elements.

According to various embodiments of the present invention, the feedback controller may includes several features. For example, the feedback controller may be configured to modify the first filter to control the selection of the elements of the first representation level transformed by the first processor. The feedback controller may also control the selection or modification of a parameter for one of the filters. The feedback controller may also adjust the first level processor to modify the transformation process from the first representation to the second representation. In yet another embodiment, the feedback controller may change the data elements included in the first representation of data elements. Also, the feedback controller may include a reasoning component for monitoring the filtered second representation of the data elements using artificial intelligence. Further by way of example, the feedback controller may be configured to modify the feedback provided in order to maximize a utility function. The feedback controller may also be configured to control the selection or modification of the filtering parameters employed by the filters.

According to another embodiment of the present invention a system for knowledge discovery from a corpus of structured data and/or semi-structured data and/or unstructured data elements is provided. The system includes a first set of one or more filters applied to a first representation of the data elements, generating a subset of those first representation data elements. The filters are configured to employ a first set of criteria to determine filter selection and filter parameters governing data element subset selection. The system also includes a first level processor configured to execute one or more processing methods for transforming the selected subset of the first representation of the data elements into a second representation level. A second set of one or more filters applied to a second representation of the data elements are also provided. The second set of filters generate a proper subset of those second representation data elements, wherein the filters are configured to employ a second set of criteria to determine filter selection and filter parameters governing data element subset selection. The system further includes a second level processor configured to execute one or more processing methods for transforming a subset of the second representation level of the data elements into a third representation having a higher abstraction than the first and second representation levels.

According to another embodiment of the present invention, the system may include a third set of one or more filters applied to a second representation of the data elements, generating a proper subset of the third representation data elements. The filters are configured to employ a third set of criteria to determine filter selection and filter parameters governing data element subset selection. The alternative embodiment may also include a third level processor configured to execute a set of one or more processing methods for identifying and characterizing relationships between the third representation of the data elements and for producing a fourth representation of data elements containing information relating to the relationship between the elements contained in the third representation.

According to other embodiments of the present invention, any of the processors may be configured to include a traceability feature so that the relationships between the data elements can be identified using the data elements as found in the prior representation levels, including traceback to source data items.

According to embodiments of the present invention, the representations may include concept classification; concept-to-concept association or concept-to-concept association includes relationship identification between associated concepts. The system may also be configured so that one of the representation levels higher than the representation that includes concept concept-to-concept association includes full syntactic and/or structural analysis of either or both complete or partial segments the source data items generating those concepts represented at the level of concept-to-concept association.

According to yet another embodiment of the present invention, a system for knowledge discovery from a corpus of structured data and/or semi-structured data and/or unstructured data is provided that includes a first level processor for transforming a subset of a first representation of the data elements into a second representation. The stems also includes a feedback controller for modifying the transformation process performed by the first level processor based on the contents of the second representation and a utility function.

According to alternative embodiments, the feedback controller may be configured in many different ways. For example, the feedback controller may be configured to modify the transformation process in order to maximize the utility function. The feedback controller may include a reasoning component that utilizes artificial intelligence. The feedback controller may be configured to modify the subset of the first representation of data elements being transformed by the first level processor. In an alternative embodiment in which the system includes a filter having a plurality of different filtering parameters for creating the subset of the first representation of the data elements, the feedback controller may be configured to control the selection or modification of the filtering parameters.

According to another embodiment of the present invention, a system for knowledge discovery from a corpus of structured data and/or semi-structured data and/or unstructured data elements is provided. The system includes a first level processor for transforming a subset of a first representation of the data elements from the corpus into a second representation having a higher abstraction than the first representation. The first level processor is configured to map the second representation of the data elements to a predetermined taxonomy containing nodes in a many-to-many manner. A feedback controller is provided and includes a reasoning component configured to monitor the second representation of data elements and to identify the population of the data in the second representation towards the taxonomy as defined by the various many-to-many mappings between the data elements in the second representation and the nodes in the predetermined taxonomy.

According to various embodiments of the present invention, the feedback controller may be configured is different ways. For example, the feedback controller may be configured to monitor metrics regarding how the second representation of the data populates toward the taxonomy. The feedback controller also may provide a feedback control signal to the first level processor in order to direct the transformation of the subset of the first representation of the data elements. The system may include a filter for creating the subset of the first representation of data elements and the feedback control signal may contain instructions relating to the selection of filter parameters to be applied to the first representation of the data elements. Further by way of example, the feedback controller may provide feedback to the first level processor in order to adapt the algorithmic methodology by which the elements of the second representation populate to the taxonomy. Also, the feedback controller may be configured to monitor the extent to which a given node within the taxonomy potentially is mapped towards by more than one distinct combination of data elements at the second representation level.

According to yet another alternative embodiment the feedback controller may be configured to adapt the predetermined taxonomic structure to include additional nodes; and wherein the first level processor is configured to map multiple distinct combinations of data elements to a first node in the predetermined taxonomic structure and also map the distinct combinations of data elements to the additional nodes in a manner that distinguishes between the multiple distinct combinations while maintaining the mapping to the nodes in the predetermined taxonomy.

According to another embodiment of the present invention a system for knowledge discovery of structured data and/or semi-structured data and/or unstructured data is provided. The system is directed to data represented in at least two different representation modalities. A separate system for processing each representation modality is provided. Each separate processing system includes a first level processor for transforming the data from a first representation level of data elements into a second representation level having a higher level of abstraction than the first representation level. The two processing systems share a common a feedback controller for automatically controlling each of the first level processors based on the contents of the respective second representation level. The feedback controller is configured to control one of the processing systems based on the data elements represented in the other of the processing systems.

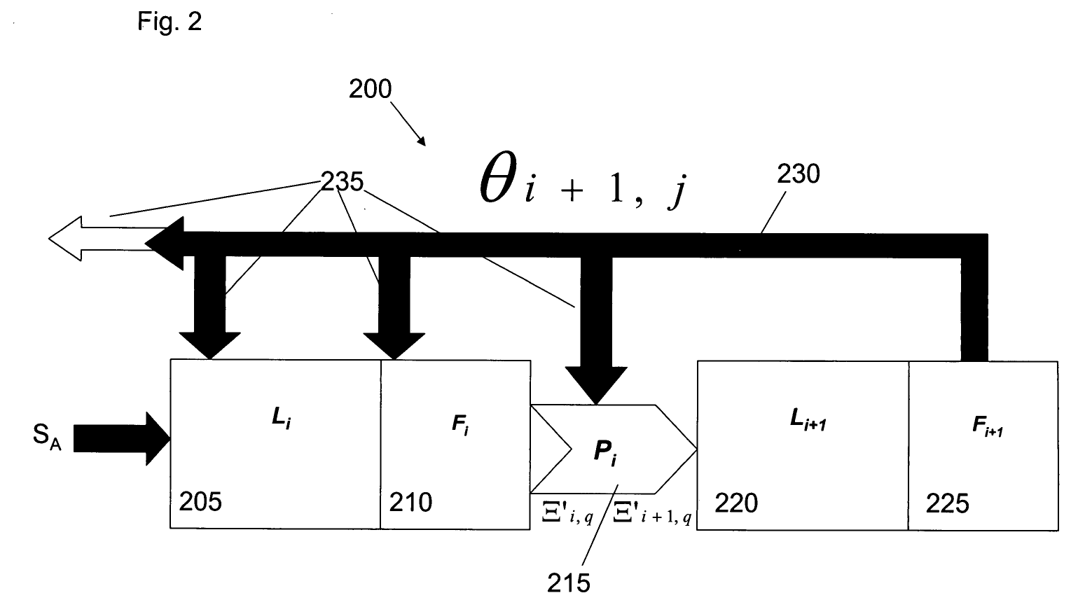

A Knowledge Discovery Architecture (“KDA”) 200 according to one embodiment of the invention is shown in FIG. 2. The KDA 200 rests on a foundation of transforming data through successively more abstract representation levels 205, 220. At each of the representation levels 205, 220, a certain amount of the data representation elements are filtered according to some criteria and these elements are further processed to yield a more abstract representation.

In order to understand the operation of the KDA 200 illustrated in FIG. 2, a notation for representing the corpora and the processed data elements and items must be established. Let S_{A} be a corpus A of source data items, which may be documents, web pages, emails, images, speech-to-text conversions, etc. Without loss of generality, the formulation will refer to the data elements within any source data item as being linguistically or text-based. S_{A}={s_{A,k}}, where k=1 . . . K is the total number of elements in the initiating corpus. Typically, K can be very large, i.e., K≈O(10^{μ}), where μ is a scaling parameter that represents the order of magnitude of corpus size.

Any given data item S_{A,k}=s(A,k)εS_{A} will typically yield via processing one or more data elements ξ, typically denoted ξₙ=ξ(n) with the subscript A denoting the corpus identification dropped, and where n=1 . . . N(k) denotes the data element index. A data element ξₙ=ξ(n) may occur at any given representation level (to be discussed in the next section), e.g., a word frequency count, a concept identification, etc. A given source data item S_{A,k}=s(A,k) will typically accrue associated multiple data elements ξₙ as data elements extracted from that source data item are processed to higher levels over successive processing steps. Further, any given data element ξₙ can in all likelihood be produced by more than one data source item and will thus have traceability back to multiple sources, and even to multiple occurrences within each of those sources.

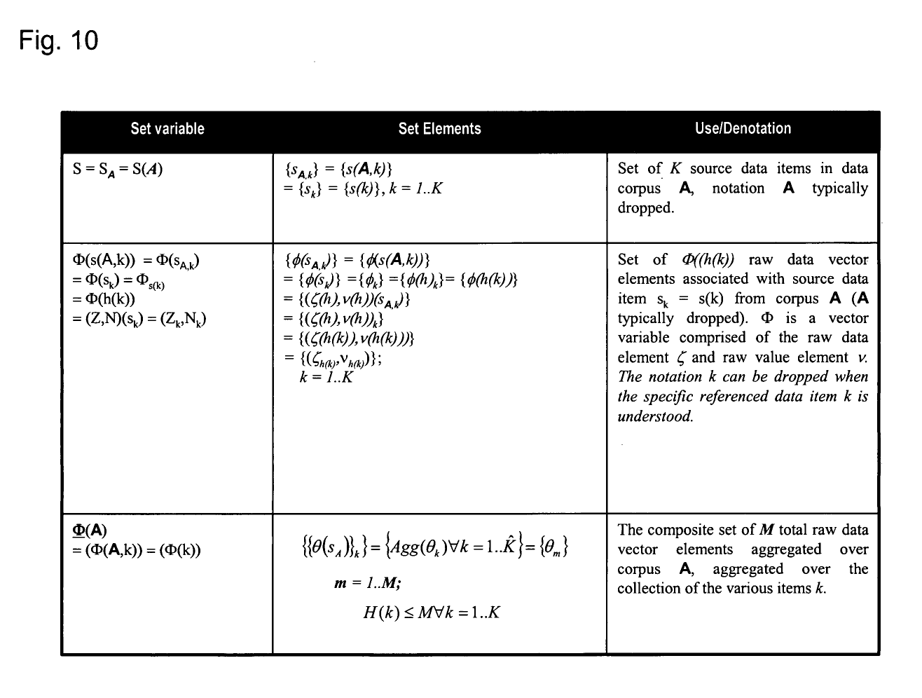

Let Ξ_{A}=Ξ(A) be the full set of data elements associated with source data items contained within S_{A}, and the subscript A is typically dropped. Then, Ξ_{A,i,q}=Ξ_{i,q}=Ξ(i,q) refers to the set of data elements at representation level Lᵢ, 205 processed during processing pass q to generate the particular set of data elements at that representation level. Then Ξ_{i,q}={ξ(n)_{i,q}}, n=1 . . . N_{i,q} where N_{i,q} refers to the total number of elements at a given representation level Lᵢ 205 for a processing pass q conducted to generate elements at Lᵢ 205. In general, there will be a many-to-many mapping between the source set of data items S_{A}={s_{A,k}} and the corresponding set of associated data elements, set Ξ_{A,i,q}={ξ_{A,i,q,}n}. FIG. 10 is a chart summarizing the notation for data items, raw data elements and aggregate data elements.

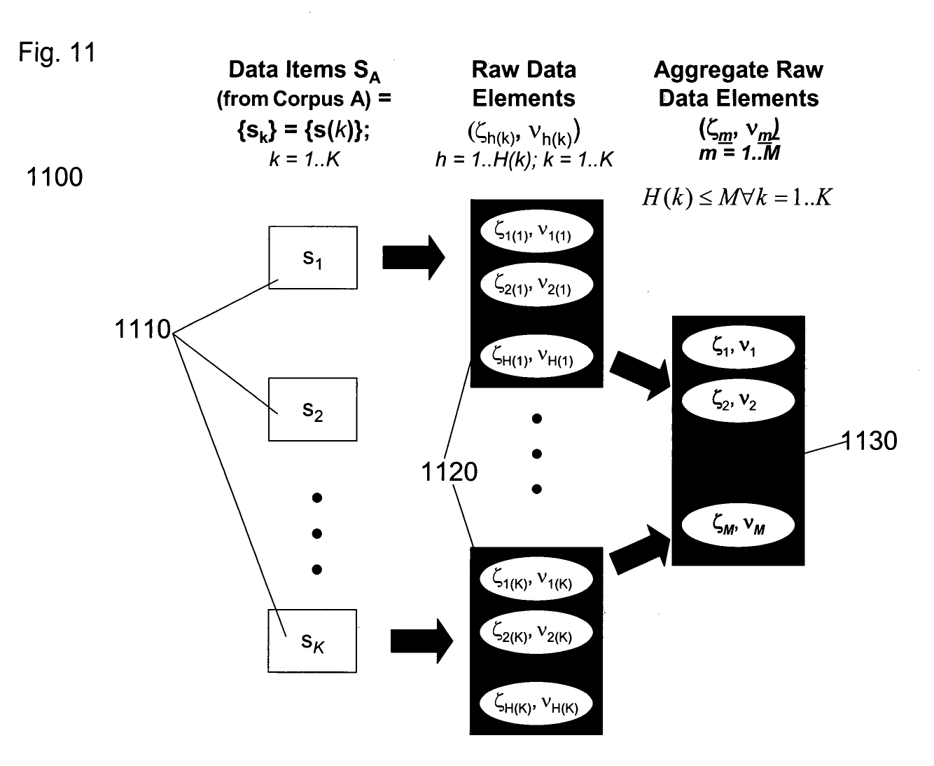

According to one embodiment of the invention, FIG. 11 is a block diagram illustrating the preliminary processing 1100 of a data corpus to identify aggregate raw data elements for higher level processing. Raw data elements 1120, such as words, pixels, etc., are extracted from data items 1110. Data items 1110 may consist of text in any format such as books or emails. In addition, data items 1110 may include video, sound, pictures, photographs or other forms of tangible information. From these raw data elements 1120 aggregate raw data elements 1130 are obtained. The aggregate raw data elements 1130 indicate how many data items 1110 (books, videos, etc.) contain the extracted raw data elements 1120 (words, phrases, pixels, etc.). Preliminary processing 1110 may be performed by a data processor (not shown). The data processor may invoke traceability back to the raw data elements 1120 for use in later processing steps. Generally, the obtained aggregated raw data elements 1130 are suitable input to a KDA 200 shown in FIG. 2.

As seen in FIG. 2, Lᵢ 205 is a predecessor representation level. Lᵢ 205 contains a set of data elements, Ξ_{i,q} obtained at representation level Lᵢ 205. Specifically, Ξ_{i,q}={ξ(n)_{i,q}} refers to the set of data elements obtained at representation level Lᵢ, from the q^{th} iteration of processing performed on data represented at a previous representation level Lᵢ₋₁ (which may refer to source data elements S_{A}) The data elements represented at Lᵢ 205 are then acted upon by a filter set Fᵢ 210.

A filter set Fᵢ 210 is associated with the representation level Lᵢ 205 where Fᵢ 210 may refer to a plurality of filters, Fᵢ={f_{i,α}}, where α=1 . . . Aᵢ, and Aᵢ is the total number of filters at Lᵢ 205. The set of filters Fᵢ 210 operate on the represented data elements Ξ_{i,q}. The filter set Fᵢ 210 applies various filtering algorithms and techniques to produce a result set Ξ′_{i,q} that will be operated on by a feed-forward transformation process, P_{i,q} 215.

The feed-forward transformation process P_{i,q} 215 operates on the set of elements Ξ′_{i,q} that have been identified for feed-forward transformational processing by application of filter set Fᵢ 210 to the data element set Ξ_{i,q}. The feed-forward transformational process P_{i,q} 215 yields a set of data elements Ξ_{i+1,q} that are stored at successor representation level Lᵢ₊₁ 220, where q is defined in terms of the q^{th} processing pass for that representation level, so here q=q(i+1).

A filter Fᵢ₊₁ 225 is associated with the representation Lᵢ₊₁ 220 where Fᵢ₊₁ 225 may refer to a plurality of filters, Fᵢ₊₁={f_{i+1, α′}}, α′=1 . . . Aᵢ₊₁, and Aᵢ₊₁ is the total number of filters at Lᵢ₊₁ 220. The plurality of filters, Fᵢ₊₁ 225 operate on the set of data elements Ξ_{i+1,q}. The filter set Fᵢ₊₁ 225 applies various filtering algorithms and techniques to produce a result set Ξ′_{i+1,q}. Generally, representation elements are filtered according to the processes described for filter set Fᵢ 210. However, the specific algorithm or technique used by filter set Fᵢ₊₁ 225 is preferably different from the algorithm used in by filter set Fᵢ 210. The result set Ξ′_{i+1,q} may be operated on by a feed-forward transformation process, P_{i+1,q} (not shown) or a feedback process Θ_{i+1,j}. 230.

As shown in FIG. 2, a feedback process Θ_{i+1,j} 230 can provide feedback signals 235 to any representation level Lⱼ (not shown) or filter Fⱼ, (not shown) where 0<=j<=i+1, and is illustrated in FIG. 2 only for the case where j=i, or to any feed-forward process P_{j′} (not shown) where 0<=j′<=i (shown only for the case where j′=i). The feedback process 230 is managed by a feedback controller (not shown). The feedback controller determines what information is provided through the plurality of feedback signals 235. As shown in FIG. 2, the feedback process in one exemplary embodiment of the knowledge discovery architecture 200 provides feedback signals 235 containing process and control data to the predecessor representation level Lᵢ 205, the filter Fᵢ 210 and the transformation process Pᵢ 215.

It is reasonable that the feedback controller can observe the data elements obtained at a given representation level Lᵢ₊₁ 220 and can identify the need for or value of having additional data elements to be brought to that level. The feedback controller may then engage a feedback signal from a given higher representation level Lᵢ₊₁ 220 to either that same level or to any prior level, for example Lᵢ 205, in order to filter and process an additional set of data elements. Should the feedback signal be directed towards a representation level prior to the one immediately preceding the representation level at which the need for additional data has been identified, then it is reasonable that the filtered and processed data will go through the nominal sequence of representation levels to arrive at the representation level where the need was identified.

Feedback signals 235 from a higher representation level to that same level or to a prior representation level can include any or a combination of the following: (1) A proper subset of data represented at that level, and/or the characteristics associated with that proper subset and/or the individual elements thereof, (2) a selection of one or more filters to be used, along with filter parameters and other data selection parameters and (3) a selection of one or more processing methods to be used, along with their appropriate parameters.

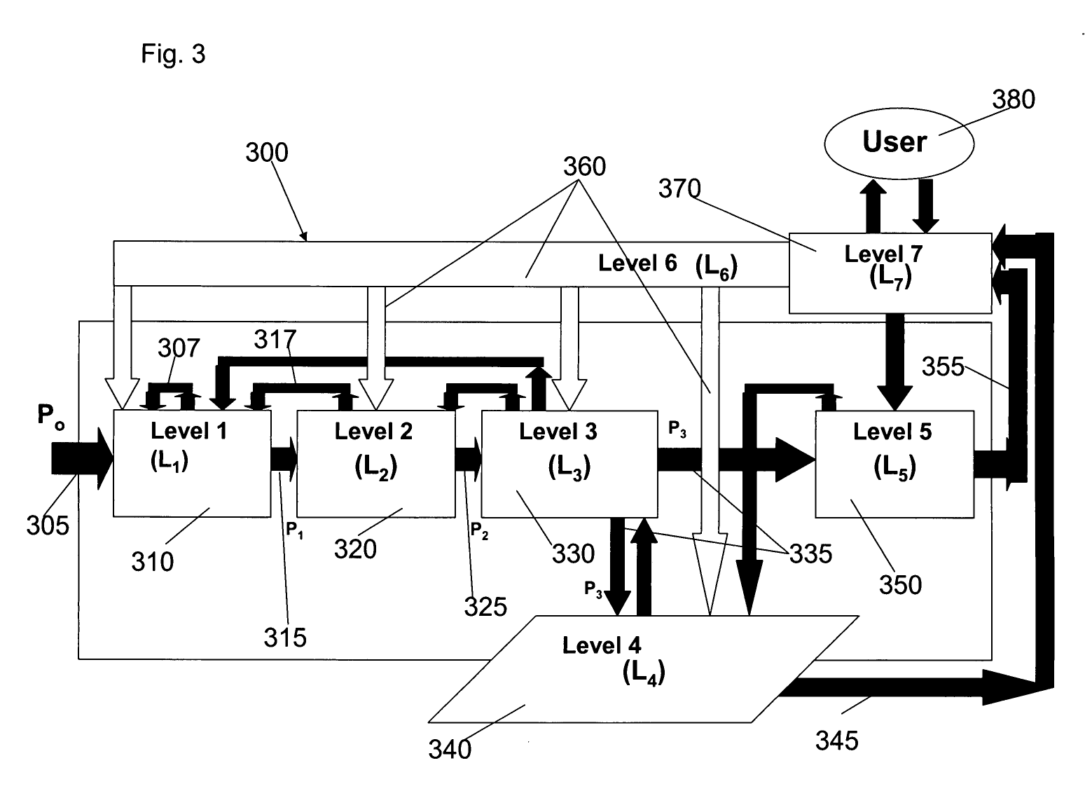

FIG. 3 illustrates a seven level KDA 300 according to one embodiment of the present invention. A level 0 (“L₀”) for ingestion and indexing is not shown. However, should L₀ ingestion and indexing be necessary to handle very large corpora, there are commercial tools that provide useful capabilities. The notion of level L₀ is reserved to refer to both data sources that have preliminarily been processed to make them available to knowledge discovery, as well as to raw data elements obtainable from these source data items. According to one embodiment of the invention, L₀ may be implemented by preliminary processing 1100 shown in FIG. 11 and described above. A search or discovery process that produces only identification of and simple statistical descriptions of the raw data elements is regarded, in this light, as a “Level 0.5” capability.

According to one embodiment of the invention, at L₀ (not shown), preprocessing and indexing of a data corpus S_{A} is performed by “tagging” each member of the corpus with one or more metatags in any such manner as is well known to practitioners of the art, whereby the metatags refer to specific identifiable elements (e.g., but not limited to, specific words, or specific content as might be found in an image) and where indexing and ingestion may be applied to any size corpus without loss of the validity or generality.

In one embodiment of the seven level KDA 300, the raw data elements extracted from source data items are processed to achieve L₁ 310 concept classification, using any of one or more concept classification (signal processing) algorithms, which may be embodied in one or more commercial-off-the-shelf (COTS) products integrated within the architectural framework. A typical and preferred processing algorithm to achieve L₁ 310 concept classes would be a Bayesian classifier, preferably using Shannon information theory to reduce the impact of highly common raw data elements. A simple Boolean implementation is also possible, but is not the preferred implementation. When implemented in the context of text processing, this serves to focus on getting those documents that have the highest, richest data relative to the inquiry.

Specifically the transformational process P₀ 305 comprises selecting those members of the data corpus whose “indices” as found and applied in L₀ are a “match” to some specified criteria, whether these criteria are set manually by a user for a given knowledge discovery task or set via an automated process, and the method by which these “index matches” are selected is any one of those well known to practitioners of the art and detailed specification of such method or development of a new “indexing” method is not essential to specifying this knowledge discovery method, nor is it essential to specify the method by which such “indexed” data corpus members are “selected” for “Transition” to the predecessor step except that the general intention of said “selection” is to reduce the size of the “selected” sub-corpus.

According to another embodiment of the present invention, P₀ 305 processing provides concept (The term “ENTITY” is used in the community to refer to a specific entity, not a concept about an entity—e.g., specific “New York City” or “Big Apple,” but not necessarily identification of these as the same concept class) extraction (classification, along with appropriate meta-tagging) from unstructured data sources. Some commercial tools provide good P₀ 305 capability where classification depends on a Bayesian membership function and where class feature vectors are weighted by saliency (i.e., via the Shannon metric).

P₀ 305 processing serves to focus on getting those documents that have the highest, richest data relative to the inquiry as the classifier is positioned to operate with a very tight sigma—i.e., a document has to have lots of hits on very simple, core keywords in order to be selected and moved forward. For this purpose, a Bayesian classifier with Shannon relevance ranking may be used.

Specifically, L₁ 310 is obtained by applying indexing and classification techniques to a data corpus S_{A} where the data corpus consists of (typically) a large to very large number of members which are typically semi-structured, and/or unstructured text, the result(s) of any form of speech-to-text conversion, and/or images or other signal-processed data, and/or any combination of such data, where the Indexing/Classification process is performed specifically as: indexing and/or classifying the members of the data corpus by appending to each member one or more metatags descriptive of the content of that member, whether that content is explicitly referenced (e.g., via “indexing,” using methods and terminology well known to practitioners of the art), or implicitly referenced using one or more of the various possible “classification” algorithms (e.g., Bayesian, or Bayesian augmented with “Shannon Information Theory” feature vector weighting), where the only specific requirement of the classification algorithm(s) at least one of the algorithm(s) employed be “controllable” through at least one parameter value (e.g., the “sigma” value in a Bayesian classifier, or more broadly, the “sigma” value, the number of elements in the prototyping “feature vector” for such a classifier, and the “feature vector element weights” applied to each element of a given “feature vector,” where these terms and associated methods are all well known to practitioners of the art, and this specification of possible parameter types is by no means exhaustive), and the end result is the set of one or more metatags so produced by application of one or more classification algorithm(s) to a given data corpus item and then associated with that item are indicative of the content of each item; and additionally a document or other source item may be classified and/or metatagged as containing one or more concept classes whose existence is inferred through the presence of certain words (typically noted as feature vectors) in that document.

In a typical instantiation, the original settings of the concept class query parameters may be set to relatively small values of “sigma,” as is commonly used in control of a Bayesian classifier, to reduce the number of returns that are generated. During the feedback process, from L₁ back to itself 307 or from higher levels, the sigma value may be modified to control the “tightness” of the return, and additionally, the selection and weightings of feature vector elements defining a given Bayesian class may be altered, and additional Bayesian classes (“concept classes”) may also be introduced for P₀ processing. In this manner, the process may be invoked, under control of Level 7 (“L₇”) 370 (which consists of a reasoning processor and a utility component) and also under control of Level 6 L₆ 360 (which consists of feedback and a utility component), multiple times, potentially returning results addressing different selected concept classes. Additionally, L₇ 370 can direct the independent analysis of the concept classes found in any set of source data items. L₇ 370 can employ any of several reasoning methodologies, such as are well-known to practitioners of the art. A typical instantiation of L₇ 370 would make use of a rules engine, an inference engine, a blackboard with multiple interacting agents, or other “intelligent” capability.

The value of the level 6 feedback loop (“L₆”) 360 and the associated L₇ 370 functionality allows the use of multiple independent or collective L₁ 310 tools. Thus, the feedback loop L₆ 360 and L₇ 370 are employed to control the processing limits without affecting fidelity by disbursing the workflow to multiple reasoning parsers.

Once the initial L₁ 310 pass is complete, application of one or more filters to the results allows either the user 380 or an automated process embedded in L₇ 370 to set the number and/or filter parameters (e.g., relevance scale) to the filters governing selection of L₁ 310 data elements for processing P₁ 315 to a second representation level L₂ 320. (It is understood that for any processing step, it may be necessary to access the source data item(s) that gave rise to the data elements selected from a given representation level.)

In still another embodiment of the present invention, a filter set F₁ (not shown) is applied to the data elements represented at L₁ 310 in preparation for P₁ processing 315. A level 2 representation level (“L₂”) 320 is obtained using P₁ processing 315. Specifically, pairwise entity association processing either on a statistical basis (e.g., using a co-occurrence matrix), or other algorithmic methods, is a common representation at Level 2. There are multiple tools available that provide both implicit P₁ processing 315, via their “taxonomy blending” when they create new categories with multiple inheritance, as well as explicit P₁ processing 315, such as is done via co-occurrence or other statistical processing. Some tools also provide a P₁ processing 315 capability in which the noun phrases are automatically “bundled” to create higher-level concept classes. These two types of tools offer complementary methods for finding pairwise associations in how they represent the associated items; either as noun phrases or as concept classes.

Once the initial P₁ processing 315 pass is complete, the L₆ 360 and L₇ 370 allow the user to set the number and/or relevance scale to the first order of the second representation level L₂ 320. The system will automatically push the most relevant sources to L₂ 320 so as to allow that portion of the system to apply its independent “noun phrase” parsing and “co-occurrence” algorithms to the classification/categorization process. The L₂ feedback 317 will then push only selected elements drawn from its new associated classification/categorization concepts back to L₁ 310 for re-computation and production and selection of concept classes, according to a filtering process applied to the data represented at L₂. This process may be repeated, depending on analysis of results according to guidance from L₇ 370, and in accordance with maximizing the utility function specified for level 2 to level 2 and/or level 1 feedback. Following the any given pass of data from L₁ to L₂, L₆ 360 and L₇ 370 may allow the second pass to L₂ 320 to take the most relevant data to the level 3 representation level (“L₃”) 330 through the processing level P₂ 325, which in one embodiment of the present invention is an independent “verb” parsing algorithm. Based on combinations of entity-based concepts with relationships or verbs, indicators for further concept extraction and/or association may then, under control of L₆ 360 and L₇ 370, be passed back from L₃ to L₂ 320 and/or to L₁ 310 for processing and/or selection of new and/or refined concepts and/or concept associations with results returned respectively to L₁ 310 and then to L₂ 320. At this point L₆ 360 has now allowed multiple sets of algorithms to apply independent sets of metadata markings that are all read in their entirety, in exactly the same fashion by the seven level KDA 300. While the user may be allowed access to data represented at any level during any point of the KD processing, this entire processing sequence just described can also be accomplished prior to the user 380 seeing the first query result.

In still another embodiment of the present invention, a filter set F₂ (not shown) is applied to the L₂ 320 representation level data elements. Specifically, the “pairwise associations” found in L₂ 320 are filtered by any one or more of various algorithmic means well known to the practitioners of this art so as to extract a subset of associations by application of one or more selection criteria, and the generality and meaning of this method is not dependent upon the specific nature of these criteria, and where a typical embodiment of this method would be to use a cut-off process selecting only those “pairwise associations” that reach a certain predefined or preset value, whether this value is fixed or determined by an algorithmic means (such as histogramming or thresholding, or any such method as is employed by the community for similar purposes), and where an extracted subset of these associations is passed to a subsequent processing level P₂ 325 for further processing.

In yet another embodiment of the invention the third representation level L₃ 330 is obtained from processing level P₂ 325, wherein in one embodiment of the invention, P₂ 325 processing uses semiotic and or syntactic processing to form “intelligence primitives” via identifying the “linking relationships” between associated entities. In a typical instantiation, L₃ 330 embodies syntactic representation of data elements (concepts) identified as being associated at L₂ 320. There are P₂ 325 processing tools in which the document text is transformed into a flat file where each word is tagged with its syntactic role. This makes it possible to ask queries about documents at this level where the queries specify, e.g., two noun phrases and yield a relationship, or a noun (or noun phrase) and a relationship and then yield the associated noun phrase.

A typical embodiment of this step would be to generate a set of subject noun-verb-object noun associations using nouns and/or noun phrases extracted from the data corpus as subject nouns (and potentially also as object nouns) and the verbs and additional object nouns are drawn from the data sources from which the data corpus at a subsequent level was extracted, although this method can also include simple subject noun-verb associations and also verb-object noun associations, and where the identifications of subject nouns, object nouns, noun phrases, concept classes, and verbs, are those common to practitioners of the art, and the resulting representation of the syntactically-associated may be either in structured (e.g., database) or other form, so long as the syntactic relationship between the associated words or phrases is represented, and may also include, without loss of generality or meaning of this method, additional grammatical annotations to the basic syntactic representation (e.g., adjectives, etc.) and any one or more noun and/or noun phrase may be replaced with an associated “concept class, “using methods that are the same or similar to those described for use in lower levels.

In another embodiment of the invention, a filter set F₃ (not shown) is applied to data elements represented at L₃ 330. Specifically, the “syntactic associations” found at L₃ 330 are filtered by any one or more of various algorithmic means well known to the practitioners of this art so as to extract a subset of associations by application of one or more selection criteria, and the generality and meaning of this method is not dependent upon the specific nature of these criteria, and this subset is passed to processing level 3 (“P₃”) 335. Additionally, application of L₇ 370 along with the level 6 feedback loop L₆ 360 can initiate feedback processes from L₃ 330 back to L₁ 310, L₂ 320 or L₃ 330 to generate additional results.

Representation level 4 (“L₄”) 340 is a product of P₃ processing 335. In another embodiment of the invention, P₃ processing 335 is a unique, neuromorphic (brain-based) component that makes it possible to find associations between various entities, even when they are separated by some degree of space/time in the originating data sets. There are several methods that enable P₃ processing 335 capabilities. The concept of a “context vector” is one for example. Further, when a structured representation has been created in L₃ of originally unstructured text, it is possible to apply pattern recognition methods for a “discovery” process. Tools with these capabilities can be used for this task. In addition, geospatial tools may be used as a means of providing geospatial data correlation, which provides physical context, and name variation capability, which will provide geographic-region context.

In still another embodiment of the invention, a filter set F₄ (not shown) is applied to data elements at L₄ 340. Specifically, the “context associations” and/or context refinements found in L₄ 340 are filtered by any one or more of various algorithmic means well known to the practitioners of this art so as to extract a subset of associations by application of one or more selection criteria, wherein the generality and meaning of this method is not dependent upon the specific nature of these criteria. The subset of corpus data generated by F₄ is passed to processing level 4 (“P₄”) 345 and is in one embodiment of the invention, matched against semantic representations at Level 5 (“L₅”) 350. Alternatively, the subset of data corpus may be passed to other processing methods available at L₄ 340.

Level 4 L₄ 340 is used to represent context, and moves the overall representation from the data elements contained within any given source data item (SDI) to characterizing the overall SDIs with regard to one another as well as with regard to taxonomies, which are expressed at L₅ 350. A typical L₄ 340 representation would be the use of context vectors, by which the various SDIs have weighted values for the entire (aggregate set of) concepts expressed throughout the source data corpus.

It is reasonable to create an instantiation of this method and system employing COTS capabilities to provide processes and data representations for certain specific elements of this architecture, within the context of an overall system.

Advantageously, the invented apparatus and method can be used to preferentially extract relatively sparse concept classes and most especially various combinations of concept classes (where each “concept class” can be expressed as a category, a set of nouns and/or noun phrases, or a single noun or noun phrase, depending on the embodiment of the invention) along with identification of the relationships (single or multiple verbs, or verb sets) linking different concept classes. At the same time, the influence of “contextual” information can be incorporated to preferentially refine a given concept class, or to add more information relative to an area of inquiry. For example, including geo-spatial references at L₄ 340 allows for “neighborhoods” surrounding a given occurrence to be preferentially tagged via feedback into the P₁ 315 process. Similarly, use of a Language Variant method at a processing level P₃ 335 can be used to identify geospatial regions of interest when a name of interest (found during P₀ or P₁ processing) is identified and then one or more Language Variants of that name are identified and represented at representation level L₄ 340. If occurrences of these proper name Language Variants are then found as a result of feedback into a lower level (e.g., representation level L₁), then the geospatially-referenced regions associated with the Language Variants provide context for later iterations of the feed-forward process that begins at representation level L₁. This is an instance by which communication between different representation modalities can be carried out. While operations at or near L₄ 340 can trigger the cross-modal communications process, capabilities for cross-modal communication is not limited to this specific illustration.

In yet another embodiment of the invention, representation level L₅ 350 is concerned with both ontological knowledge sources (including taxonomies) as well as both “deep” and “commonsense” knowledge. Although several tools, with varying degrees of capability, exist at the semantic level, these tools are typically processing-intensive and should be reserved for extracts for which previous-level processing indicates a high value.

At L₅ 350, data corpus members selected during the previous filtering and processing are represented as “semantic associations” and “semantic meaning and/or interpretation” using one or more of a variety of methods, such as are known to practitioners of the art, so as to extract further refinement of associations, concept classes and additionally any knowledge-based and/or semantic-based information that can be associated with the elements of the data corpus.

In another embodiment of the invention, L₆ 360 can exist between multiple levels in the system. For example, at representation level L₂ 320 the “hot spots” in the co-occurrence matrix find the most significant pairwise associations. This yields a new set of keywords, potentially indicating one or more different concept classes, to use in addition to the initial query. The keywords and/or concept classes include additional “features” of the target entity, as well as entities associated with this target entity. The system then generates a more specific and focused processing level P₀ 305. In this second round, governed by the “feedback” from the processing level Pi 315 the system is able to add the additional feature keywords as well as the association entity-keywords. (In practice, this could spawn multiple P₁ 315 processes, each focusing on a different association.) This then yields a new representation level L₂ 320 set of associations that provided answers to our original query.

In another embodiment of the invention, L₇ 370 is used in conjunction with the feedback and feed-forward process. Both alerts and agents work at this level. The purpose of L₇ 370 is to select parameters and invoke processes that produce “best value” results. L₇ 370 thus provides a metric by which a proposed feedback action can be measured, and the overall performance of the system improved. Multiple utility functions used by L₇ 370 are typically required because there are several independent axes that may be used to determine effectiveness. A capability such as a rule-based ranking and decision-making system can be used to provide both a template for feedback decision-making as well as user alerting/notification. It was illustrated above how L₇ 370 would carefully channel the representation level L₂ feedback into representation level L₁, so that the resulting representation level L₁ searches were tightly focused on the desired outcome. This methodology employs the indexing schema in the same manner for structured and unstructured data; however, the system may employ the specific use of structured data OLAP tools to address the feedback loop L₆ 360 independently from the noun phrase or verb parsing.

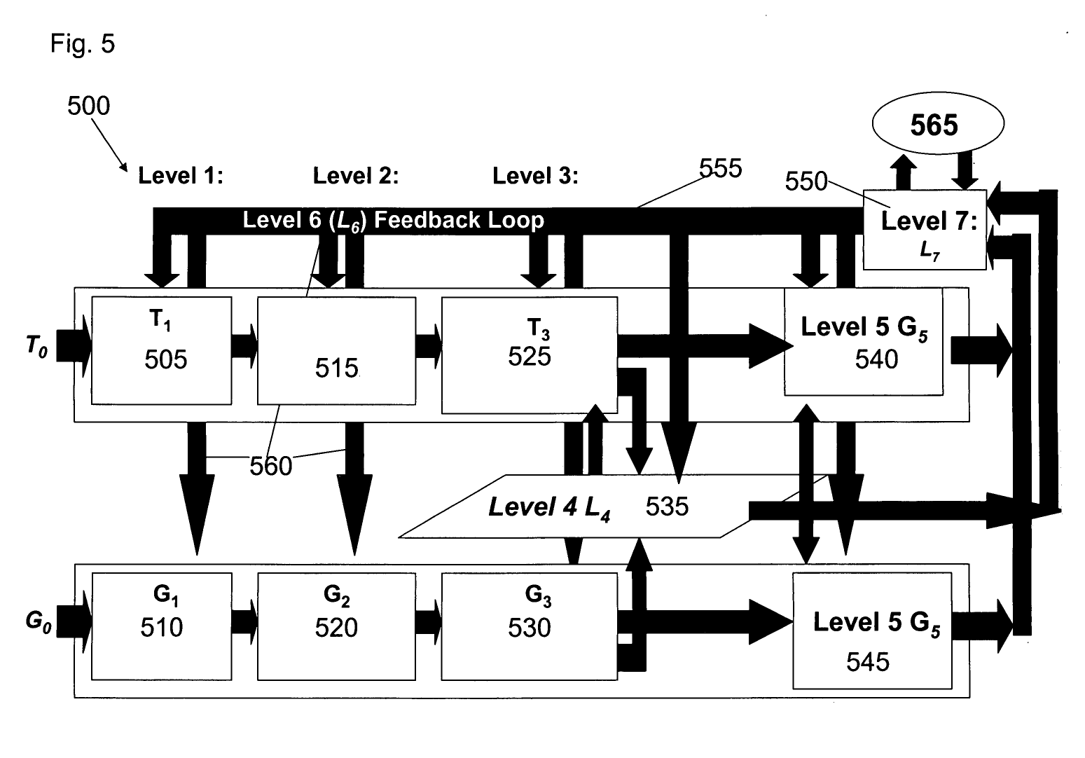

According to another embodiment of the invention, an advanced seven level KDA 500 is shown in FIG. 5. The advanced seven level KDA 500 accepts textual based data T₀ and geospatial based data G₀ as inputs. The inputs are processed and represented at level 1 505, 510 as concept classes T₁ and unique events or locations G₁. The information at each level 1 instantiation 505, 510 is filtered by a filter (not shown) and processed to yield a level 2 representation 515, 520. For text based data, the level 2 representation 515 consists of concept-to-concept matches T₂. For the geospatial data, a level 2 representation 520 consists of event or location associations G₂. The information at the level 2 representation level is filtered and processed to yield a level 3 representation level 525, 530. Data at the level 3 representation level 525 for text based data is represented as concept relationships T₃ whereas data at the level 3 representation level 530 for geospatial based data is represented as event or location relationships G₃. For each specific instantiation the data represented at level 3 is filtered and processed. The results of the process yield the level 4 representation L₄ 535. The data at the level 4 L₄ 535 representation level is further filtered and processed to yield a fifth representation level 540, 545. For geospatial based data the level 5 350 representation level G₅ 545 provides location information in an ontological and taxonomical context. Similarly the fifth representation level T₅ 540 for text-based data provides an ontological and taxonomical structure for the data. The data represented at each level 5 instantiation 540, 545 is further filtered, processed and evaluated by a level 6 utility function as part of the feedback loop L₆ 555 and a level 7 reasoning function L₇ 550. The functionality of the level 6 utility function L₆ 555 and level 7 reasoning function L₇ 550 in FIG. 5 is the same as described above including accepting and outputting data to a user 565. The advanced seven level KDA 500 also has a level 6 feedback loop L₆ 555 which can exist between multiple levels in the system. As shown in FIG. 5, the feedback loop L₆ 555 may provide feedback signals 560 to both the text based and geospatial based data representation levels. The functionality of the feedback loop L₆ 555 is similar to that of the feedback loop 360 in FIG. 3, described above.

It is clear to any practitioner of the art that there is a risk in “filtering” data elements from one level to identify the proper subset of data elements that will be processed for representation at the next higher level. This risk is that potentially very relevant data elements might not be selected for the next step of data processing. While this risk could be addressed by adjusting filter parameters to pass through a fractionally large subset of the data elements at one level, this works against the goal of making careful and judicious use of the more complex algorithms and processing methods. Instead, the approach embodied in one embodiment of this invention is to select a subset that is reasonable for further processing according to a specified set of criteria, knowing that it is likely that not all relevant data elements will be selected. Once these data elements have been filtered, processed, and brought forward into the next and more abstract representation level, the reasoning processor at L₇ can be invoked to determine whether additional data elements at that level should be sought. Should this be the case, then the reasoning processor will be charged with causing one or more additional sets of lower-representation-level data elements to be selected for further processing, and thus bringing the resultant more abstract and complex data elements up to the representation level of the set under consideration.

The reasoning processor should accomplish this task not so much by identifying those specific lower-representation-level data elements to be selected, but rather by identifying data elements at the level currently being considered that would be appropriate for initiating related data element selection at the lower level(s), and by adjusting both filter methods and parameters as well as algorithm/processing method selection and parameters to achieve the desired state, potentially in an iterative manner. Any “iterative” or multiplicity of feedback processes can be carried out in parallel as well as in a sequential architectural embodiment, without altering the functionality of this invention.

By this method of judiciously and iteratively (possibly performed in parallel) selecting sets of data elements for processing to higher representation levels, and using feedback to generate additional sets of data elements as needed, it is possible to meet the first objective stated as one of the major challenges addressed by this invention; the appropriate use of processing resources on relevant data, to increase speed and minimize computational expense.

In addition to making best use of processing resources, and thus achieving overall system speed and minimizing computation expense, the use of directed feedback has another benefit: Both knowledge discovery precision and comprehensiveness are achieved through use of feedback from higher representation levels to lower ones, under the guidance of a reasoning processor. While the description of the invention emphasizes the role of various representation levels, this does not eliminate the use of “blackboards” and other common representation means that facilitate reasoning processes from examining the contents at any given representation level, forming and posting hypotheses, and directing actions (including potentially those of invoking and obtaining inputs from various agents) with regard to the data elements represented at any given level. However, for clarity, the description of this invention focuses attention on the feedback process between levels, and in particular addresses the role of diverse utility functions driving the feedback process from any given level to any lower level or, in some cases, back to itself.

Feedback from any one level to a lower level, or in certain cases, to itself, is guided by use of a utility function that is specific to each defined type of feedback (i.e., from one level to another). Each potential feedback situation has a unique utility, or function which can be maximized (or for which a maximum can be approached, while staying within a rule-specified level-of-effort). The specification of utility functions is typically unique to a particular instantiation of the architecture with a given selection of specific tools, COTS components, or algorithms performing the process of generating a given representation Lᵢ₊₁ from the previous representation level Lᵢ, and also to the unique specification of filters Fᵢ used to extract data elements from that level Lᵢ for a given processing pass q.

The process of maximizing utility for the various utility functions is the means by which the KDA balances different competing objectives (e.g., precision vs. comprehensiveness).

The following illustrates, but does not limit, the kinds of utility functions that would be satisfied with feedback loops according to one embodiment of the KDA 300.

The level 5 (350) to level 1(310) Feedback Utility Function (U(L5=>*L1)=U(L₅=>*L₁), where the “*” notation refers to the action of feeding back into a given representation level according to one embodiment of the invention will now be described. The goal of this feedback loop is typically to increase the discernability of concept classes as expressed at the first representation level (L1=L₁). Typical measures expressing discernability are minimum least squared error, often used in neural networks to determine the weights of a back-propagating Perceptron. Similarly, a Mahalanobis distance expresses both the inter-class distance as well as intra-class distances for a pairwise consideration of two concept classes. Without being inclusive, these are representative of typical utility functions that could be satisfied for driving L5=>*L1 feedback, governing the processes for any given set of taxonomic nodes that are all direct children of the same parent node, that is the set {N_{I}} of nodes that are children to a given node n(I), where I specifies the taxonomic path. Various methodologies for the process have previously been discussed, and are understood to be not inclusive of the methods or utilities that can be identified to have a taxonomic structure used to refine concept class specifications.

The level 5 (350) to level 2 (320) Feedback Utility Function (U(L5=>*L2)=U(L₅=>*L₂) according to one embodiment of the invention will now be described. One valuable purpose of the L5=>*L2 feedback loop is that it can usefully guide concept aggregation at the concept-to-concept association representation level (L₂ 320). For example, in one set of source data items, S_{A}, the discussion can be focused on relations between moderate and conservative Republicans in the United States. In a different source set S_{B}, or even in the same source set S_{A}, there can be discussion of relations between Republicans (as a whole) and Democrats. In the first case, it is useful to make the distinction (the concept class) of “moderate Republicans” versus the concept class of “conservative Republicans,” which is a further taxonomic specification of the “Republican” node under the “political party” node for a “U.S. Social Structure” node. (using these taxonomic node identifications for illustrative purposes only). In the second case, the distinction between the two subclasses of “Republican” can obfuscate the interaction that is more properly occurring between two higher-level taxonomic nodes. Thus, it would provide greater clarity to group the two Republican subclasses into a higher-level conceptual aggregate, even at L₂ 320, than to consider them individually. The feedback from L₅ 350 to L₂ 320 can help accomplish this, by identifying the presence of concepts that match to higher-level taxonomic entities (e.g., both Republicans and Democrats, and possibly, Independents). Thus, the utility function governing the L5=>*L2 feedback loop operates on identification of taxonomic matches for associated concepts expressed at L₂ 320, and moves to create concept-aggregates and/or higher-order concept class invocations at L₂ 320 which can then associate with other concepts in a manner more suited to their taxonomic relationship.

The level 5 (350) to level 3 (330) Feedback Utility Function (U(L5=>*L3)=U(L₅=>*L₃) according to one embodiment of the invention will now be described. The goal of the L5=>*L3 feedback loop is similar to L5=>*L2 feedback loop utility except that the L5=>*L3 feedback loop focuses on identification of the appropriate taxonomic level for characterizing relationships between two concepts, which may be expressed in various ways. For example, the relationships between two political or religious groups can be expressed using terms such as “meet,” “negotiate,” and “discuss,” all of which could be subsumed into single relationship category. Similarly, relationships such as “agree to,” “ratify,” and “reach accord” can also be subsumed into a single relationship category. Further, these can be viewed as interactions spanning a neutral-to-positive continuum of interactions, and thus can be grouped at a higher taxonomic level for relationships, as compared to interactions indicating hostilities, disagreements, or disaccords. The value of aggregating relationships between associated concepts is that similar interactions can be grouped together, providing for abstraction of the simplest possible representations that carry full meaning. Utility here then rests on semantic similarity (according to a taxonomy of relationships), subject to inputs from both the user and automatically generated inputs from context and history.

The level 5 (350) to level 4 (340) Feedback Utility Function (U(L5=>*L4)=U(L₅=>*L₄) according to one embodiment of the invention will now be described. Several distinct types of events occur at or near the L₄ 340 representation, including (1) identification of context for a given discovery, (2) entity extraction and communication (entity passing) to another representation modality, and (3) invoking structured data processing (data analytics). The L5=>*L4 feedback loop utility is dominantly applicable to the first of these three cases. The remaining two cases are discussed in the context of utility for feedback from L₄ 340 to other representation levels.

When the L5=>*L4 feedback loop utility is invoked for context determination, the process is similar to the L5=>*L1 feedback loop utility, except that the L5=>*L1 feedback focuses on determining which specific concepts, associated with localized representation in their respective source data items, are being identified and associated with specific taxonomic nodes, leading to clarification of concept class specification. In contrast, at the Context representation level (L₄), the seven level KDA 300 recognizes that typically many concepts, and consequently many taxonomic nodes, are associated with a given source data item (SDI).

The purpose of L₄ Context is twofold. First it provides a mechanism by grouping related SDIs so that the groups can be distinguished from each other, and simultaneously identified according to cohesive “regions of similarity.” It also provides a means by which context can be added to a given SDI that may be incompletely specified with regard to taxonomic relationship. In this latter case, the context provides a “virtual wrapper” to the SDI. Alternatively, it can be viewed as providing “assumed or extrapolated metadata” in the form of generating additional metadata tagging associated with a given SDI, along with an indication that this additional metadata tagging has been provided by ancillary reasoning processes and was not inherent to original SDI.

The role of utility is different for these two cases of context usage. In the first case, it can provide a means, either directed by a user or by an autonomous reasoning process, by which the relative values or rankings of various SDI descriptives (e.g., feature vector element weights representing the degree to which a concept or group of concepts is present) to be varied based on a taxonomic correspondence of the various concepts. This allows a user or automated reasoning process to preferentially organize SDIs according to primary dimensionalities of description, e.g., geophysical dominating over functional role specification. The utility function is thus a function of taxonomy selection, taxonomy branch and depth identification (from associated concepts within an SDI), and also of preponderance and relevance of concepts, concept associations, and relationships, identified at levels 1-3 of the seven level KDA 300.

In the second case of context usage, whereby “assumed or extrapolated” metadata is associated with a given SDI, the utility function will govern how broadly or narrowly a specific set of taxonomic associations is made with a given SDI, as a function of several variables, which may or not be present, including but not limited to factors such as: (1) user profile (if available), (2) transaction/behavior/query history (if available), (3) actual user feedback indicating preferred context (if available), as well as feasible contexts offered via taxonomy inputs, characterizing possible taxonomic paths for one or more concepts within a given SDI. In the latter case, a given possible taxonomic path for a specific concept in given SDI may typically be associated, in a manner independent of any specific user's profile, transaction/behavior/query history, or feedback, with certain other taxonomic paths.

For example, a query about “Madonna” can reasonably refer with high probability to one of two well-known incidences of “Madonna,” the popular singer or the religious figure from the Christian religion. Certain key words associated with “Madonna” may be insufficient to indicate context; e.g., the word “prayer” may equally well refer to the musical release “Like a Prayer,” or to the devotional act of prayer. Thus, the association of “prayer” with “Madonna” does not serve to well-specify context. However, certain geospatial references, e.g., “Vatican,” embodying a completely different taxonomy, are more typically associated with the religious figure and thus can help identify context. This is an illustration of “typical” close association between elements of one kind of taxonomy (“Persons”) with another (“Geospatial”), which can be used to imbue context to SDIs when full taxonomic specification using a single taxonomy (e.g., “Persons”) would be more problematic.

The Level 4 (340) to Structured Analytics and/or Other Representation Modality Feedback Utility Function (U(L4=>*Structure), U(L4=>*(Alt-L1 . . . L3)) according to one embodiment of the present invention will now be described. Utility functions play a role in the two other operations that typically occur at or proximal to L₄ 340; cross-modal representation communication and invocation of structured data analytics. Both of these processes often depend on entity extraction and identification from an SDI, which is typically accomplished using L₃ 330 processing to extract named persons, organizations, places, things, and the like.

Utility Function(s) for level 4 (340) to levels 1, 2, or 3 (U(L4=>*L1), U(L4=>*(L2), and U(L4=>*(L3)) according to one embodiment of the present invention will now be described. In manners similar to those previously described, utility function(s) governing feedback from the context determination can be used to focus concept specifications, preferentially select and aggregate concepts, concept associations, and concept-to-concept relationships. Further, addition/identification of a (set of) primary relationship-type(s) to a given concept-to-concept (or plurality of concepts and their associations) provides a means by which a group of SDIs can be thematically characterized. Also, by identifying aggregate levels of both concepts and relationships, L₄ 340 context information can be used by the reasoning processor (L₇ 370) as well as by one or more utility functions to drive rule sets regarding concept aggregation according to taxonomic organization as well as to indicate which possible taxonomies can be simultaneously invoked as defining different aspect of the same situation, thus assisting reconfiguration of the related and associated higher-order concepts (corresponding to higher levels within a taxonomy). This will enable significant concept-to-concept associations and relationships to become more apparent, as they can then be represented by higher-level concepts corresponding to higher-level taxonomic nodes, and also more comprehensive or higher-level relationship definitions.

Utility Function(s) for level 3 (330) to levels 1 (310), 2 (320), or 3 (330) (U(L3=>*L1), U(L3=>*(L2), and U(L3=>*(L3)), for level 2 (320) to levels 2 (320) or 1 (310) (U(L2=>*L1), U(L2=>*(L2), and for level 1 310 to itself (U(L1=>*L1) according to one embodiment of the invention will now be described. Utility function(s) governing feedback from representations of concept-to-concept relationships, concept-to-concept associations, and concept extractions to the same or lower levels are typically governed by statistical considerations as well as by rules and priorities established by higher reasoning processes embedded within L₇ 370. Specifically, typical instances of a utility function governing L₃ 330 to a lower level (or to itself) will focus on whether a given concept-to-concept relationship that is identified at L₃ 330 either meets certain “significance” or “relevance” criteria; typically taken in conjunction with one or more of the concepts with which it is associated. This can spawn feedback to the same or lower levels to identify either additional concepts associated with one of the original concepts associated with the identified relationship, plus the relationship itself, or to seek for additional instances or different types of relationships between the two concepts. Criteria impacting L₂ 320 feedback utility can range from simple thresholding on instance-counts of concept-to-concept associations, up to more complex methods that are either dependent on or independent of the particular concepts involved. Criteria involving L₁ 310 feedback to itself typically include, but are not limited to, a combination of statistical metrics characterizing the returns from the processes generating a given set of L₁ 310 data elements, along with metrics characterizing their query relevance.

Once an entity has been extracted from an SDI, a utility function can be applied to determine whether or not structured data analytics should be invoked. For example, matching of a name (or name variant) against a watch list can invoke analytics performed on a non-US person seeking to enter the country. As another example of a utility function, a second name, again for a non-US person, that is associated with an identified watch-list person through L₂ 320 concept association, can be screened against a utility function for invoking further analytics before being permitted access to the U.S.

Similarly, utility functions for propagating extracted entities as well as concepts and concept associations and relationships towards alternate representation modalities can take into account not only specific extracted entities but also the overall context in which these entities occur (e.g., the context vector for the SDI or portion of an SDI from which the entity was extracted). For example, an extracted entity of “Paris Hilton” (a popular celebrity) identified as either the person or a Hilton hotel in Paris. If the Hilton hotel is identified via context, then the entity can be targeted towards a geospatial representation, and if the overall SDI has a context of travel, then restaurants, shops, and the like within the immediate vicinity can be associated with the discovery process. Further, level 5 processes operating on this geospatially-identified entity can be used to “zoom in” and “zoom out” of the geospatial taxonomy surrounding the location of a Hilton hotel located in Paris, France. In this manner, taxonomic structures interact with queries or discovery elements to govern the association process. A knowledge discovery process that has a high utility for finding relevant associations would return a rich set of findings near the hotel, a knowledge discovery process for which the relevant association utility has been set to a low value would minimize such returns.

The seven level KDA 300 uses a feedback loop 360 from the L₅ 350 ontology/taxonomy representation level to the L₁ 310 concept extraction and representation level to facilitate taxonomy-driven distinctions in how any given source data item (and also the set of data elements associated with one or more of these items) should be distinguished. On this basis, it is possible to create metrics defining how a given corpus populates towards a taxonomy, i.e., the degree (either as a integer population or as a fraction of the total) to which any given node is populated. It is further possible to specify the “distance” between the populations assigned to any given neighboring set of nodes, whether the neighbor-relationship is vertical (one node is a “parent” of the other), or horizontal (two or more nodes are “children” of the same “parent” node.)

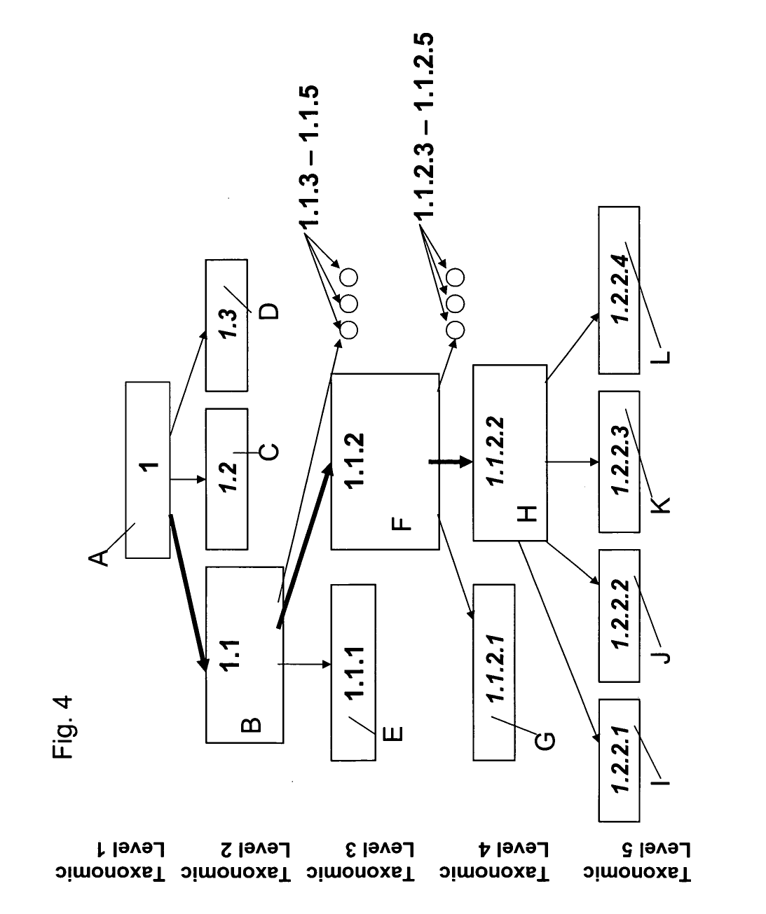

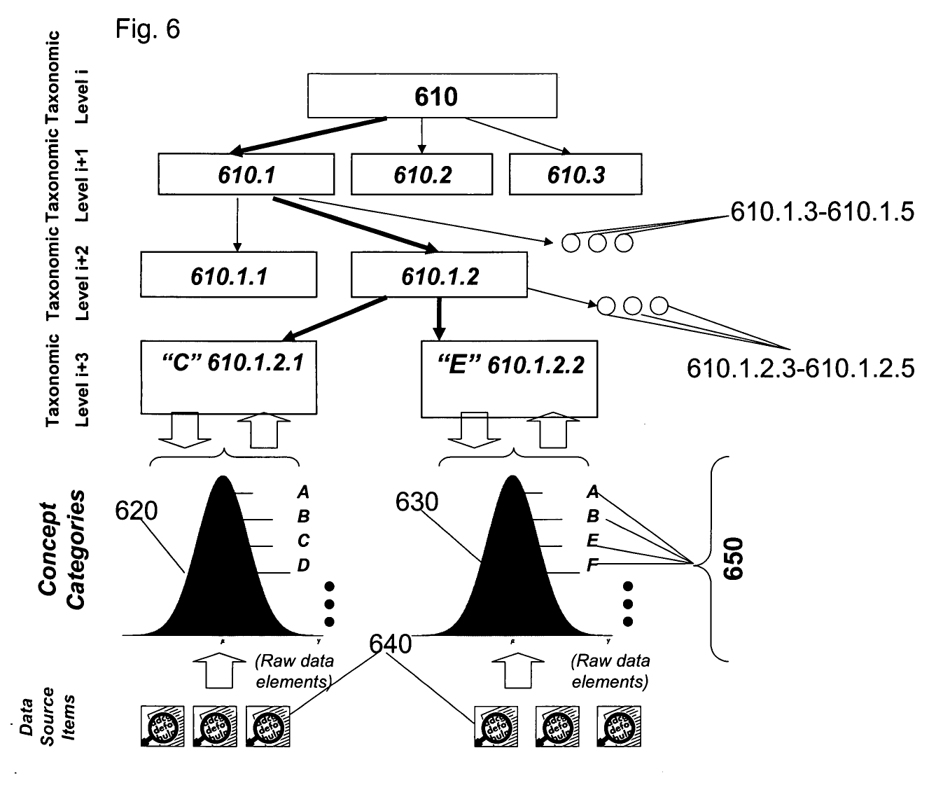

The core concept underlying the seven level KDA 300 for using a taxonomy specification to improve discernability between classes of data items associated with the various taxonomic nodes is expressed in FIGS. 4 and 6.

FIG. 4 is an exemplary illustration of a possible taxonomic structure that may be developed by one embodiment of the present invention. Each numbered node denotes a representation of a taxonomic node in the overall taxonomic structure. Ordering of nodes from left to right is independent of specific value or meaning in the taxonomy. Each numbered node denotes a representation of processed data elements at a taxonomic representation level L.

A given ontological/taxonomic path within a structure is denoted I, where I specifies how to get from the root node to the parent of given node. This parent node is designated by its path, n_{I}. Note that I specifies a full path, and is thus a condensed notation. The taxonomic level or depth at which a given node is identified is denoted L. A given path I will have depth L(I).

A given ontological/taxonomic node that is a child of the parent specified as n_{I}. is given as n_{I,j}=n(I,j); j=I . . . J, where J is the “width” of the number of nodes directly children to node n_{I}.

The set of nodes n_{I,J}=n(I,j) directly under node n_{I}=n(I) is given as N_{I}=N(I), where N₁={n(1,j)|I}={n_{i,j}|I}, j=1 . . . J, where the notation {nⱼ|I} identifies all those nodes n_{I,j} that are children to the parent specified by path I.

A given node n_{I,j}=n(I,j) may have K direct children. A given ontological/taxonomic path from node n_{I,j}=n(I,j) to one of its children is denoted K, where K, a condensed notation, specifies how to get from n_{I,j}=n(I,j), the given child node of I, to n_{I,j,K}=n(I,j,K), the specified child node at path K.

The full set of child nodes (direct children and their descendents) to a given node n_{I}=n(I) is given as N*_{I}=N*(I), where N*₁={n(I,j,\hat{K})|I}=n_{1,j,\hat{K}}|I}, j=1 . . . J; \hat{K}ε{K|j}∀K where the notation \hat{K}ε{K|j} identifies all those nodes n_{I,j,K}=n(I,j,K) that are children to the parent n_{I,J}=n(I,j).

For example, referring to FIG. 4, the parent path associated with the node labeled (“F”) would be described as the parent path I=1.1.2, for taxonomic level 1 root node (1), first taxonomic level 2 child from root (1.1), and second taxonomic level 3 child from the previously identified taxonomic level 2 child (1.1.2).

For an exemplary taxonomic node at path I, the set of J child nodes to this parent node at path I are denoted N_{I}, where N_{I}={nⱼ|I}, j=1 . . . J. A given child node j is designated fully as n_{I,j}, with shorthand notation nⱼ, where j specifies the jth node of the set of J nodes that are children to I. For example, the full path specification for the exemplary node labeled (“H”) at taxonomic level 4 is n_{I,j}=(1.1.2.2).

FIG. 6 is a block diagram illustrating the correlation between a particular taxonomical node and concept classes according to one embodiment of the present invention. A parent node 610 has several children nodes that are defined to have a specific meaning. A child node “C” 610.1.2.1 has one or more concepts 620 associated with it. The child node “C” 610.1.2.1 is defined toward a particular concept set of {C_{γ}}={C(γ)}, γ=1 . . . Γ, is associated with the specific node n(610.1.2.1) as shown in FIG. 6, where {C_{γ}} defines the total number of concepts for that node. Consider that each concept may be specified by an appropriate feature vector, one of which is illustrated in FIG. 6 (620). Similarly, the sibling node “E” 610.1.2.2 is defined toward a particular concept set {E}, where each concept in set {E} is similarly defined (630). Because the children both share properties in common with their parent, the parent node 610.1.2 will have associated with it a concept set where the member concepts are similarly characterized by feature vectors (as one means for describing the concepts, which does not limit the generality of this method). The associated concepts 620 and 630 for each node have both unique as well as repeated feature vector elements 650 (“FVEs”), where in the illustration, feature vector elements A and B are common to both children (and presumably also to the parent), and feature vector elements C and D are unique to one of the concepts associated with 620, and feature vector elements E and F are unique to one of the concepts associated with 630. As shown in FIG. 6 the FVEs 650 are weighted so that data source items 640 can be mapped toward the appropriate nodes

Of the various feedback loops within the seven level KDA 300, the one that exerts greatest control towards the overall knowledge discovery process is the one in which semantic knowledge guides the lower-level processes, e.g., signal extraction and identification (also referred to as concept extraction), as well as concept association, concept-to-concept relationship identification, and context determination. With regard to concept extraction, it is useful to represent semantic knowledge in terms of ontologies and taxonomies, where ontologies represent a structured “world-view” or organization of the world, and specifically identify the most crucial distinctions, and the order in which these distinctions should be made, to organize world knowledge (concepts and/or concept-to-concept relationships) in a coherent manner. Taxonomies are typically instantiations of a given ontology towards a specific situation in the world. For example, there can be a general conceptual organization, or ontology, for a corporate organization structure, and a specific taxonomy for a given, unique organization.

While a taxonomy can exist independent of any given corpus or set of corpora, and in many instances does have an independent existence (e.g., taxonomies of pharmaceuticals, taxonomies of animals and plants, etc.), there are many cases in which a taxonomy can be usefully specified towards a given corpus. In this case, the specification process provides greater clarity in identifying how a given source data item, or its respective components, should be associated with specific nodes and/or sets of nodes within a given taxonomy. In this perspective, the nodes at one level can be viewed as “class identifications” for a classification problem, and the challenge is then to identify those combinations of data elements from within a data source item, either taken as an entirety or as specific components of that source, that lead to preferential association with specific nodes as they represent classes in a standard classification task.

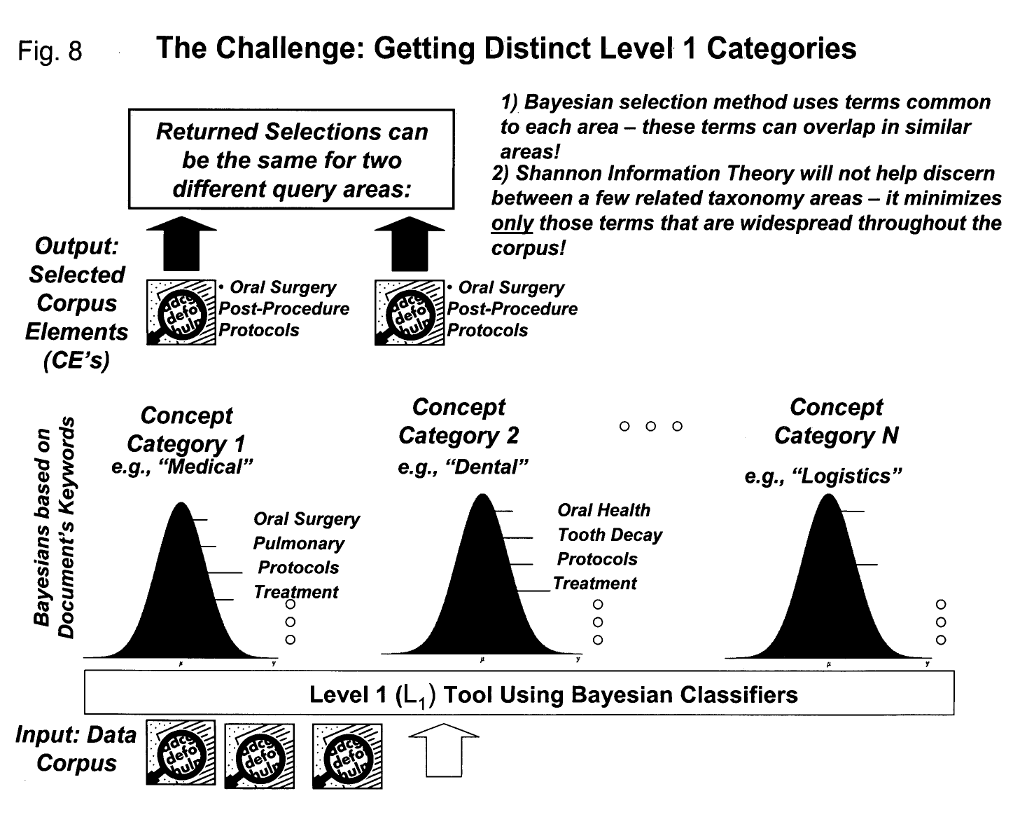

FIG. 8 is a block diagram illustrating how distinct representation level 1 categories are obtained. Input data is processed using a Bayesian selection method to yield a plurality of concept categories each having a plurality of data elements that are weighted. Selected weighted elements are then output as the selected corpus elements.

This approach embraces the many methods that have previously been defined for improving classifier performance, for which Bayesian classification methods and neural networks are two well-known examples. In one embodiment of the present invention the traditional classifier problems are addressed using a set of “training data,” for which the “correct” association between the source data item and the appropriate classification is pre-identified. The correct association is then used to establish parameters (e.g., Bayesian classifier values, neural network weights, etc.) that will enable the chosen method to produce the “best possible” solution that it can achieve, dependent on the method used. The important point is that the existence of correctly classified training data is presumed.

In contrast, the methods currently providing “concept extraction” from source data elements do not rely on a complete set of ab initio concept classes. In part, this is a strength of these “unsupervised” methods, as they allow users to define concept classes uniquely suiting their particular inquiries, and mitigate against the potential need to identify all of the concept classes with which a given source data item could associate. There is, however, a huge downside to this approach. It means that there is no well-specified means by which similar concept classes can be well-distinguished against each other. The result is that material which should preferentially be “classified” according to one specific class may well be classified (or identified as associated with) multiple classes.

The means by which this difficulty can be addressed is not only to identify a well-founded set of ontologies and taxonomies to describe world-views (so that users can construct inquiries via combinations of multiple taxonomic elements), but also to provide the taxonomies with a means of “feeding back” distinctions even at the concept-class definition level, so that associations between source data items to taxonomic nodes can be focused.

This feedback is accomplished by recognizing that a source data item (“SDI”) can contain a multitude of “raw data elements,” which are extracted from the SDI. These “raw data elements” are of the same nature as the fundamental signal-level representation of the SDI, so that if the SDI is text-based, then the raw data elements (“RDEs”), are words, including nouns, noun-phrases, word stems, and the like. Similarly, if the SDI is an image, the RDEs are pixels, pixel groups, etc. Further identification of RDEs for various data sources is typically straightforward for practitioners of the art.

While a given SDI will contain one set of RDEs, it is generally the case that a larger set of RDEs characterizes those RDEs contained within a set of SDIs. This set of RDEs that can be extracted from any member of a set of SDIs contained within a corpus is referred to as the “aggregate RDE set.” There is thus a many-to-many mapping, between any SDI and one or more RDEs that are elements of the aggregate set. Typically, any RDE in the aggregate RDE set may also be “mapped-to” by more than one SDI.

The “signals” or “concepts” that are identified as unique classes typically can be referenced, or associated-to, by more than one possible combination of RDEs. For example, a “concept class” defining New York City could be referenced by New York, New York city, Manhattan, or by “the Big Apple.” Each of these noun phrases can be considered a RDE. Similarly, many concept classes can be referenced by multiple RDEs.

Also, a given RDE, or even a set of RDEs, may associate with multiple concept classes. Indeed, the means by which a concept class can be preferentially “associated-to” is not so much the presence or absence of a given RDE, but rather one of possibly a multiple of patterns of RDE combinations that indicate one concept class more than another.

Similar to how it is possible for multiple, differently specified and weighted or combined sets of RDEs to indicate a given concept class, it is also possible for a given concept class to be associated with more than one taxonomic node, and further, for multiple concept classes to associate (perhaps in various unique combinations) with a given taxonomic node.

We now see that it is possible for a given SDI to have associated with it a multiplicity of RDEs, for these RDEs to associate with and indicate the presence of multiple “concept classes” referenced by the SDI, and that these (perhaps multiple) “concept classes” can further associate with taxonomic nodes, either individually or as one of a possible multiplicity of uniquely specifiable combinations. This allows the formation of a “backward chain” of evidential reasoning that associates one or more taxonomic nodes with a given SDI. This can be accomplished by a variety of methods, e.g., neural network auto-associative networks, evidential reasoning and labeling as used in artificial intelligence, etc., to name but a few.

If this process were to be carried out in an “unsupervised” manner, there would in most cases be a lack of clarity in assignment of “best possible” taxonomic nodes to any given SDI, or to a specific component of a given SDI.

One embodiment of the present invention is thus directed towards improving the focus of possible sets of the SDI-to-taxonomic node classifications, resulting in an increase in the assignments (or assignment values) of classifications that are regarded as “better” than others, by some metric, and diminishing the number of (or the assignment value of) those classifications that can be considered as less optimal, again using some metric.

This process can be carried out through judicious combination of several components comprising a methodology. One component includes use of a human-in-the-loop to assist in determining which SDIs should preferentially be classified with a given taxonomic node to a greater degree than with its peers, its parent, or its possible children. This amounts to having human selection of a training data set in order to implement a supervised learning method, such as is done to obtain feature vector element weights for a Bayesian classifier or to train weights for a back-propagating neural network.

A second component involves judicious selection of a method for adjusting the set of RDE-to-concept class assignments (including potentially a multiplicity of different sets of weighted RDEs, combined via one or more functions, e.g., as would be done with a back-propagating multilayer perceptron neural network), and in conjunction with this process, the process of adjusting the set of concept-class to taxonomic node assignments.

In another embodiment of the invention, a third component, recognizes that the selection, training, and adjustment processes just described are not limited to working with a single set of concept classes or taxonomic nodes that are, in either case, at the same “level” of hierarchical consideration. Rather, certain concept classes are broader than others and can subsume several or many more particular concept classes. Also, by definition, certain taxonomic nodes encompass a broader definition of corresponding associations than those nodes that are direct children or “descendents” of that node.

An SDI may be associated with a given taxonomic node following any of (or possibly a combination or all of) a path of bottom-up, independent, or top-down association. In the case of top-down association, a given SDI is characterized according to which of the possible highest-level nodes or “branches” of a taxonomy it should be associated. (Note that because a given SDI can contain a multiplicity of RDEs, and thus embody a multiplicity of concept classes, any single SDI can potentially be associated with a multiplicity of taxonomic nodes, based on different combinations of the potential multiplicity of RDEs present and their associated concept classes.)

Tracing the course of a given SDI's association with a given taxonomic node or even a set of similar and related nodes, which together may have some proximity to each other, both “vertically” (parent/child) and “horizontally” (siblings of the same node), the SDI associates enough with a higher given level node in order to indicate which path the SDI might follow down the taxonomic hierarchy, associating with greater degrees of relevance as it reaches the node for which a given combination of RDEs present in the SDI have the highest “match,” via concept matching as previously described. The association process is somewhat analogous to “sieving” an SDI to find the level of granularity as well as particularity to which one of its RDE combination sets is most well-matched.

In order to improve the focus to which an SDI can match a taxonomic node at any given level, it is useful to recognize that during top-down association, the higher-level nodes will necessarily be defined more broadly than their children nodes. Further, all the children nodes under a given parent will meet the criteria for satisfying the parent node, which typically are one of “is-subclass-of,” “is-a-component-of,” “is-used-by,” or “is-related-to” criteria. So for example, in a taxonomy of animals, then if a particular taxonomic node refers to mammals, it is given that all the children under that node will be kinds of mammals. A certain set of attributes are used to define the “mammals” node. It is unnecessary to use these attributes to define the lower level nodes, because it is given that an animal being classified to a lower level node has already been identified as having the characteristics of the higher level node.

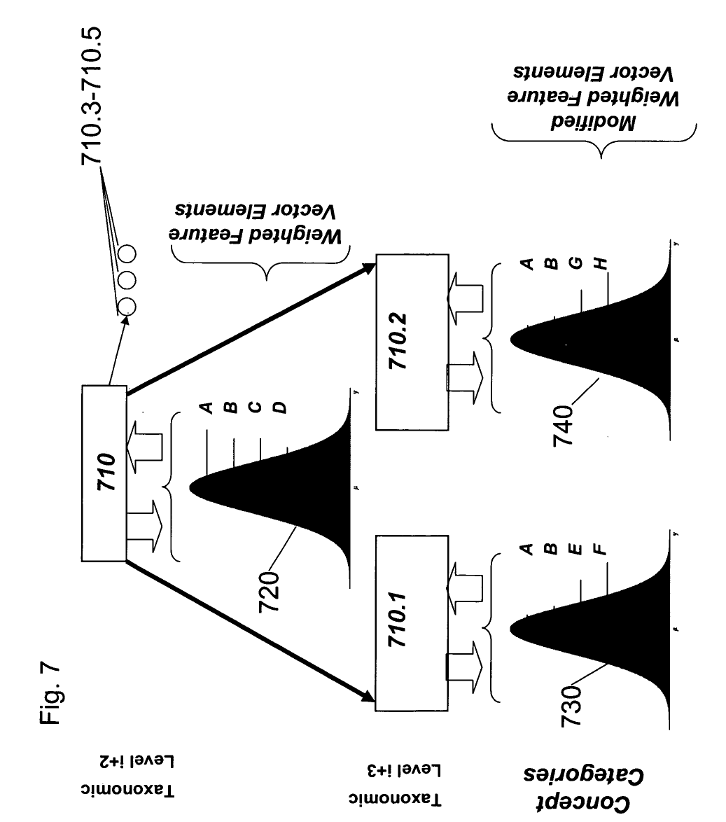

FIG. 7 is a block diagram illustrating how Feature Vector Elements may vary between taxonomic node levels. A parent node 710 has associated with it a set of concepts 720, for which one of the concepts is illustrated with the weighted feature vector elements A, B, C, and D. As shown the parent node 710 has the feature vector elements A and B in common with its child nodes 710.1 and 710.2.

This means that the set of data attributes used to characterized the children of a given parent node vice each other need not contain those data attributes that are used to distinguish the parent from its siblings. This fact can then be used to adjust both the membership and the functional combination rules (e.g., weightings) of the data attribute sets corresponding to the children a given node vice those that characterize the parent. This thus makes possible a process of first establishing the data attributes of a given parent node vice its siblings, and then characterizing the diverse children of that parent vis-a-vis each other.

The process of adjusting the data attribute set memberships and combination rules (e.g., various weightings) is still not trivial, as it is being considered less in abstraction and more in dependence on the various RDEs available within a corpus. Thus, while one may speak abstractly in terms of “mammalian characteristics” that need not be further identified when distinguishing various species of mammals, it is understood that those characteristics are always present. This is not always the case when dealing with data that may not contain all the data attributes present that could conceivably characterize an SDI towards a given taxonomic branch. Part of the task of “filling in” such missing data is the function of context determination.

However, it is reasonable that if not all, the great majority of both RDEs as well as concept classes that could characterize an SDI towards a given taxonomic node or branch can be specified using material found within an SDI corpus. One means for accomplishing this is to use a sparse feature vector set, where each position in the feature vector corresponds with a given RDE that is specifiable from that corpus (an aggregate RDE). A separate feature vector set would similarly contain the set of concepts that are specifiable from various combinations of the RDEs. The methodology described in the following paragraphs, while specifically directed towards refinement of RDEs associated with different concepts, could just as readily be applied towards refinement of concept sets associated with different taxonomic nodes.

This methodology uses the concept of a feature vector to describe the RDEs present in an SDI, along with an aggregate feature vector describing the set of aggregate RDEs present in a set of SDIs. The feature vector elements may be vectors themselves, specifying multiple values associated with a given RDE, e.g., its frequency, “relevance” (according to some metric), etc. For purposes describing this methodology, we shall treat the FVE as a scalar value, without loss of generality of the method.

Without loss of generality, it is also possible to “reorganize” the feature vector elements (FVEs) of a given feature vector into three major groups: First, those that can be used to associate an SDI with a higher-level taxonomic node (up through the parent of a given set of sibling nodes) comprise one group. (This is equivalent to identifying those attributes that identify a certain object as first, an animal, then as a mammal, etc.) Second, those FVEs that can usefully distinguish match appropriateness between the SDI and a given node (e.g., subclass) among a set of sibling nodes provide another group. The third group contains those FVEs that are not useful for matching the SDI against one of the different sibling nodes under a given parent.

Thus, both the feature vector element selection and combination rules for matching an SDI among a set of taxonomic nodes that are siblings with one another can be focused towards the “second group” of RDEs, that is, the RDE group which is capable of distinguishing among the various taxonomic nodes that are children to the same given parent. The methods for accomplishing this are well known to practitioners of the art. Once this step has been accomplished for any given taxonomic level, it is possible to proceed, iteratively employing this method, for successive sets of children in a taxonomy.

The concepts of the various representation levels, filters, and processes creating data transitions between levels, along with feedback loops and their utility functions, applies equally well to image-based, sensor-based, and geospatial-based data representations. Further, geospatial data representation, while having much in common with image processing in that it deals with two, and possibly three or even four (including time) relationships between data, involves more abstract conceptualization, as well as mapping from the abstract to a supposed “real world” reference. Due to its abstract nature, and the possibility for decoupling different representation levels within a geospatial representation system (e.g., distinguishing between the baseline terrain elevation depiction vice vegetation/foliage, vice extended and point terrain features, vice both enduring and transient man-made features) implicitly invokes human ability to think in terms of multiple overlaying representations on the same base representation framework. Iconic representation elements are typical in a geospatial representation system, where the icons are chosen because they carry “semiotic” information for the users, but reference directly to specific objects and/or point or extended features, as opposed to processing the pixel-level data embodied in the graphical display of a geospatial representation.

Geospatial representations thus are distinct from image processing, whether human or computer-based. Image processing typically involves multiple representation levels of processing, working from the lowest level of pixel data up through features, advanced or combined features, to higher-order representations and finally to image interpretation.

For this reason, we consider image-based representation and processing to be a uniquely different representation modality from either geospatial representation or text-based representations.

Thus, in terms of major representation modalities, one embodiment of the present invention considers text-based, image-based, geospatially-based, and sensor-based data streams to be different although potentially related at various points of confluence. One intention of this invention is to provide a mechanism for communicating knowledge (data elements and associated context and higher-level knowledge) across the various representation modalities as is both appropriate and needed for knowledge discovery.

The hardware requirements to run the seven level KDA 300 will vary depending on application and user requirements. According to one embodiment of the invention the seven level KDA 300 may be implemented with a CPU, a memory unit, a hard drive, and an operating system is all that is necessary. The operating system can be a commercially available system such as Windows, Windows XP Pro, UNIX or Linux. In addition to the computing system, access to data sources is required. The data sources may reside on the same computer system used by the seven level KDA 300 or be accessible via a network or Internet connection. The user interfaces with the seven level KDA 300 via a web browser. Preferably the web browser resides on a separate computer system.

According to another embodiment of the invention, preferably, the hardware configuration for supporting the seven level KDA 300 will consist of multiple CPUs. Multiple CPU's are preferred because of software component incompatibilities that implement the algorithms utilized at the various levels of the KDA 300. Multiple CPUs can be utilized either at each level or at multiple levels. Whether a representation level requires one or more CPU's will be based on the speed required to process the data and the amount of data to be processed. For example at higher representation and processing levels the algorithms become more complex and require greater amounts of time to process the same amount of data processed at a preceding level.

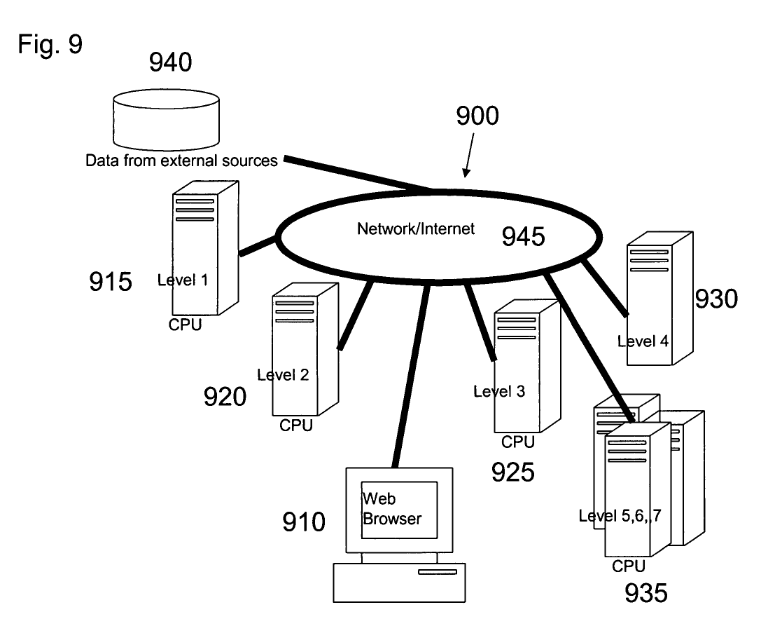

FIG. 9 is a hardware architecture 900 for implementing the seven level KDA 300 according to one embodiment of the present invention. A user system 910 is operatively connected to a network 945 of CPU's. External data sources 940 are operatively connected to the network 945. A level 1 CPU 915 is operatively connected to the network 945. The level 1 CPU 915 is capable of performing all functions for obtaining representation level L₁ including functions for carrying out processing level P₀ and F₁ filtering. A level 2 CPU 920 is operatively connected to the network 945. The level 2 CPU 920 is capable of performing all functions for obtaining representation level L₂ including functions for carrying out processing level P₁ and F₂ filtering. A level 3 CPU 925 is operatively connected to the network 945. The level 3 CPU 925 is capable of performing all functions for obtaining representation level L₃ including functions for carrying out processing level P₂ and F₃ filtering. A level 4 CPU 930 is operatively connected to the network 945. The level 4 CPU 930 is capable of performing all functions for obtaining representation level L₄ including functions for carrying out processing level P₃ and F₄ filtering. As shown in FIG. 9 a cluster of CPUs 935 is operatively connected to the network 945. The cluster of CPUs 935 is capable of performing all functions associated with the L₅, L₆ and L₇ representation levels including the L₇ feedback loop 360 and L₆ utility function 370. L₅, L₆ and L₇ representation levels reside on cluster of CPUs 935 due to the computing resources required to operate the algorithms related to each representation level.

It should be understood that various changes to and modifications preferred in the embodiment described herein would be apparent to those skilled in the art. Such changes and modifications can be without demising it attendant advantages. It is therefore intended that such changes and modifications be covered by the appended claims.

1. A system for knowledge discovery from a set of structured data and/or semi-structured data and/or unstructured data elements comprising:
a first filter for filtering a first representation level of the data elements;
a first level processor for transforming the filtered data elements into a second representation level of the data elements;
a second filter for filtering the second representation of the data elements; and
a feedback controller for automatically providing feedback to one of the filters and/or the processor and/or to the first representation level of data elements based on the filtered second representation level of the data elements

2. The system of claim 1, wherein the second representation level of the data elements is at a higher level of abstraction than the first representation level of the data elements.

3. The system of claim 1, further comprising a data processor for extracting raw data elements from source data items and transforming the raw data elements into the first representation level of the data elements.

4. The system of claim 1, wherein the feedback controller modifies the first filter to control the selection of the elements of the first representation level transformed by the first processor.

5. The system of claim 1, wherein the feedback controller controls the selection or modification of a parameter for one of the filters.

6. The system of claim 1, wherein the feedback controller adjusts the first level processor to modify the transformation process from the first representation to the second representation.

7. The system of claim 1, wherein the feedback controller changes the data elements included in the first representation of data elements.

8. The system of claim 1, wherein the feedback controller includes a reasoning component for monitoring the filtered second representation of the data elements using artificial intelligence.

9. The system of claim 8, wherein the feedback controller modifies the feedback provided in order to maximize a utility function.

10. The system of claim 1, wherein the feedback controller modifies the feedback provided in order to maximize a utility function.

11. The system of claim 1, further comprising a second level processor for transforming the filtered second presentation of the data elements into a third representation level of the data elements.

12. The system of claim 1, wherein the first filter comprise a plurality of different filtering parameters.

13. The system of claim 1 1, wherein the feedback controller is configured to control the selection or modification of the filtering parameters.

14. A system for knowledge discovery from a corpus of structured data and/or semi-structured data and/or unstructured data elements comprising:
a first set of one or more filters applied to a first representation of the data elements, generating a subset of the first representation data elements, wherein the filters are configured to employ a first set of criteria to determine filter selection and filter parameters governing data element subset selection;
a first level processor configured to execute one or more processing methods for transforming the selected subset of the first representation of the data elements into a second representation level;
a second set of one or more filters applied to a second representation of the data elements, generating a subset of the second representation data elements, wherein the second set of filters are configured to employ a second set of criteria to determine filter selection and filter parameters governing data element subset selection;
a second level processor configured to execute one or more processing methods for transforming a subset of the second representation level of the data elements into a third representation having a higher abstraction than the first and second representation levels.

15. The system of claim 14, further comprising:
a third set of one or more filters applied to a second representation of the data elements, generating a proper subset of the third representation data elements, wherein the filters are configured to employ a third set of criteria to determine filter selection and filter parameters governing data element subset selection; and
a third level processor configured to execute a set of one or more processing methods for identifying and characterizing relationships between the third representation of the data elements and for producing a fourth representation of data elements containing information relating to the relationship between the elements contained in the third representation.

16. The system of claim 14, wherein each of the processors is configured to include a traceability feature so that the relationships between the data elements can be identified using the data elements as found in the prior representation levels, including traceback to source data items.

17. The system of claim 14, wherein one of the representations includes concept classification.

18. The system of claim 17, wherein one of the representation levels higher than the representation that includes concept classification includes concept-to-concept association.

19. The system of claim 18, wherein one of the representation levels higher than the representation that includes concept-to-concept association includes relationship identification between associated concepts.

20. The system of claim 18, wherein one of the representation levels higher than the representation that includes concept-to-concept association includes full syntactic and/or structural analysis of either or both complete or partial segments the source data items generating those concepts represented at the level of concept-to-concept association.

21. The system of claim 14, further comprising a feedback controller for modifying the transformation process being performed by one of the processors and/or for modifying filter selection and filter parameter determination and/or for modifying one of the representations of the data.

22. The system of claim 21, wherein the feedback controller operates to maximize a utility function.

23. The system of claim 21, wherein the feedback controller includes a reasoning component configured to monitor the representations of the data being formed by the processors.

24. A system for knowledge discovery from a corpus of structured data and/or semi-structured data and/or unstructured data elements comprising:
a first level processor for transforming a subset of a first representation of the data elements into a second representation;
a feedback controller for modifying the transformation process performed by the first level processor based on the contents of the second representation and a utility function.

25. The system of claim 24, wherein the feedback controller is configured to modify the transformation process in order to maximize the utility function.

26. The system of claim 24, wherein the feedback controller includes a reasoning component.

27. The system of claim 24, wherein the reasoning component utilizes artificial intelligence.

28. The system of claim 24, wherein the feedback controller is configured to modify the subset of the first representation of data elements being transformed by the first level processor.

29. The system of claim 24, wherein the system includes a filter having a plurality of different filtering parameters for creating the subset of the first representation of the data elements.

30. The system of claim 29, wherein the feedback controller is configured to control the selection or modification of the filtering parameters.

31. The system of claim 24, wherein the feedback controller changes the data elements included in the subset of the first representation of data elements.

32. The system of claim 24, further comprising a filter for creating a subset of the second representation of the data elements.

33. The system of claim 32, wherein the feedback controller includes a reasoning component for monitoring the filtered second representation of the data elements using artificial intelligence.

34. The system of claim 32, further comprising a second level processor for transforming the filtered second representation of the data elements into a third representation level of the data elements.

35. The system of claim 24, further comprising a data processor for extracting raw data elements from source data items and transforming the raw data elements into the first representation level of the data elements.

36. A system for knowledge discovery from a corpus of structured data and/or semi-structured data and/or unstructured data elements comprising:
a first level processor for transforming a subset of a first representation of the data elements from the corpus into a second representation having a higher abstraction than the first representation,
wherein the first level processor is configured to map the second representation of the data elements in a many-to-many manner to a predetermined taxonomy containing nodes in a many-to-many manner;
a feedback controller including a reasoning component configured to monitor the second representation of data elements and to identify the population of the data in the second representation towards the taxonomy as defined by the various many-to-many mappings between the data elements in the second representation and the nodes in the predetermined taxonomy.

37. The system of claim 36, wherein the feedback controller is configured to monitor metrics regarding how the second representation of the data populates toward the taxonomy.

38. The system of claim 36, wherein the feedback controller provides a feedback control signal to the first level processor in order to direct the transformation of the subset of the first representation of the data elements.

39. The system of claim 38, further comprising a filter for creating the subset of the first representation of data elements and wherein the feedback control signal contains instructions relating to the selection of filter parameters to be applied to the first representation of the data elements.

40. The system of claim 36, wherein the feedback controller provides feedback to the first level processor in order to adapt the algorithmic methodology by which the elements of the second representation populate to the taxonomy.

41. The system of claim 37, wherein the feedback controller is configured to monitor the extent to which a given node within the taxonomy potentially is mapped towards by more than one distinct combination of data elements at the second representation level.

42. The system of claim 36, wherein the feedback controller is configured to automatically adapt the predetermined taxonomic structure to include additional nodes in order to distinguish between combinations of data elements in the second representation.

43. The system of claim 36, wherein the feedback controller is configured to adapt the predetermined taxonomic structure to include additional nodes; and wherein the first level processor is configured to map multiple distinct combinations of data elements to a first node in the predetermined taxonomic structure and also map the distinct combinations of data elements to the additional nodes in a manner that distinguishes between the multiple distinct combinations while maintaining the mapping to the nodes in the predetermined taxonomy.

44. A system for knowledge discovery of structured data and/or semi-structured data and/or unstructured data comprising:
wherein the data is represented in at least two different representation modalities; and wherein a separate system for processing each representation modality exists; and wherein each separate processing system includes a first level processor for transforming the data from a first representation level of data elements into a second representation level having a higher level of abstraction than the first representation level, and
wherein the two processing systems share a common a feedback controller for automatically controlling each of the first level processors based on the contents of the respective second representation level;
wherein the feedback controller is configured to control one of the processing systems based on the data elements represented in the other of the processing systems.

45. The system of claim 44, wherein each of the processing systems includes a second level processor for transforming data from the second representation level into a third representation level.
